(19) United States
(12) Patent Application Publication
(10) Pub. No.: US 2011/0005723 A1
(43) Pub. Date: Jan. 13, 2011

(54) IONIC LIQUID STABILIZER COMPOSITIONS

(76) Inventor: Nandini C. Mouli, Reisterstown, MD (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/678,173

(22) PCT Filed: Sep. 26, 2008
(86) PCT No.: PCT/US08/77837

§ 371 Date: Mar. 15, 2010

Related U.S. Application Data
(60) Provisional application No. 60/975,947, filed on Sep. 28, 2007.

(51) Int. Cl. F28D 15/02; C09K 5/04

(52) U.S. Cl. 165/104.21; 252/67; 252/68; 977/734

(57) ABSTRACT

The present invention relates to compositions comprising at least one ionic liquid and CF₃I; and mixtures thereof. Such compositions may be useful as low GWP working fluids. These compositions have a variety of utilities in working fluids, which include for example, blowing agents, solvents, aerosol propellants, fire extinguishants, sterilants or heat transfer mediums (such as heat transfer fluids and refrigerants for use in refrigeration systems, refrigerators, air conditioning systems, heat pumps, chillers, and the like).

### BACKGROUND OF THE INVENTION

1. Field of the Invention

The present invention relates to compositions comprising at least one ionic liquid and iodotrifluoromethane (CF₃I). The use of an ionic liquid in the compositions stabilizes the compositions. The stabilized compositions may be useful in cooling systems as replacements for existing working fluids with higher global warming potential.

2. Description of Related Art

New environmental regulations on working fluids have forced the refrigeration and air-conditioning industry to look for new working fluids with low global warming potential (GWP). There are numerous other applications for fluorocarbon working fluids, such as in the area of fire suppression, in preparation of foams as expansion agents, and as aerosol propellants, to mention a few.

Replacement working fluids are being sought that have low GWP, no toxicity, non-flammability, reasonable cost and excellent performance.

CF₃I has been proposed as a working fluid alone or in mixtures. However, it has been observed that CF₃I can exhibit degradation by itself (e.g., high temperature) and/or produce useful products or unwanted by-products when contacted with other compounds (e.g., moisture, oxygen, and condensation reactions with other compounds) that may be present in a particular use and/or application. Such degradation may occur when CF₃I is utilized as a refrigerant or heat transfer fluid. This degradation may occur by any number of different mechanisms. In one instance, the degradation may be caused by instability of the CF₃I at extreme temperatures. In other instances, the degradation may be caused by oxidation in the presence of air that has inadvertently leaked into the system. Whatever the cause of such degradation, because of the instability of the CF₃I, it may not be practical to incorporate it into refrigeration or air-conditioning systems.

Therefore, there exists a need to stabilize proposed low GWP replacements such as CF₃I.

### SUMMARY OF THE INVENTION

To avoid possible instability of CF₃I at the extremes of system operation (especially at high temperatures), it has been found that adding specific compounds, namely ionic liquids, to compositions comprising CF₃I will increase the stability thereof and allow use in refrigeration or air-conditioning system applications, among other applications.

Therefore, in accordance with the present invention, a composition is provided comprising at least one ionic liquid and CF₃I. Such compositions may be useful as low GWP working fluids.

Also provided is a method for reducing degradation of a composition comprising CF₃I, wherein said degradation is caused by the presence of inadvertent air in a refrigeration, air-conditioning or heat pump system, said method comprising adding an effective amount of at least one ionic liquid to the composition comprising CF₃I.

Also provided is a method for reducing reaction with oxygen for a composition comprising CF₃I; said method comprising adding an effective amount of stabilizer comprising at least one ionic liquid to the composition comprising CF₃I.

### DETAILED DESCRIPTION OF THE INVENTION

The present invention provides a composition comprising at least one ionic liquid and CF₃I.

These compositions have a variety of utilities in working fluids, which include, for example, blowing agents, solvents, aerosol propellants, fire extinguishants, sterilants or heat transfer mediums (such as heat transfer fluids and refrigerants for use in refrigeration systems, refrigerators, air conditioning systems, heat pumps, chillers, and the like).

A blowing agent is a volatile composition that expands a polymer matrix to form a cellular structure.

A solvent is a fluid that removes a soil from a substrate, or deposits a material onto a substrate, or carries a material.

An aerosol propellant is a volatile composition of one or more components that exerts a pressure greater than one atmosphere to expel a material from a container.

A fire extinguishant is a volatile composition that extinguishes or suppresses a flame.

A sterilant is a volatile biocidal fluid or blend containing a volatile biocidal fluid that destroys a biologically active material or the like.

A heat transfer medium (also referred to herein as a heat transfer fluid, a heat transfer composition or a heat transfer fluid composition) is a working fluid used to carry heat from a heat source to a heat sink.

A refrigerant is a compound or mixture of compounds that function as a heat transfer fluid in a cycle wherein the fluid undergoes a phase change from a liquid to a gas and back.

In one embodiment, the present compositions comprise at least one ionic liquid and CF₃I (iodotrifluoromethane). CF₃I is commercially available or may be made by known processes.

Ionic liquids are organic compounds that are liquid at room temperature (approximately 25° C.). They differ from most salts in that they have very low melting points, they tend to be liquid over a wide temperature range, and have been shown to have high heat capacities. Ionic liquids have essentially no vapor pressure, and they can either be neutral, acidic or basic. The properties of an ionic liquid can be tailored by varying the cation and anion. A cation or anion of an ionic liquid useful for the present invention can, in principle, be any cation or anion such that the cation and anion together form an organic salt that is liquid at or below about 100° C.

Many ionic liquids are formed by reacting a nitrogen-containing heterocyclic ring, preferably a heteroaromatic ring, with an alkylating agent (for example, an alkyl halide) to form a quaternary nitrogen-containing salt, and performing ion exchange or other suitable reactions with various Lewis acids or their conjugate bases to form the ionic liquid. Examples of suitable heteroaromatic rings include substituted pyridines, imidazole, substituted imidazole, pyrrole and substituted pyrroles. These rings can be alkylated with virtually any straight, branched or cyclic O₁₋₂₀ alkyl group, but preferably, the alkyl groups are C₁₋₁₆ groups, since groups larger than this may produce low melting solids rather than ionic liquids. Various triarylphosphines, thioethers and cyclic and non-cyclic quaternary ammonium salts may also been used for this purpose. Counterions that may be used include chloroaluminate, bromoaluminate, gallium chloride, tetrafluoroborate, tetrachloroborate, hexafluorophosphate, nitrate, trifluoromethane sulfonate, methylsulfonate, p-toluenesulfonate, hexafluoroantimonate, hexafluoroarsenate, tetrachloroaluminate, tetrabromoaluminate, perchlorate, hydroxide anion, copper dichloride anion, iron trichloride anion, zinc trichloride anion, as well as various lanthanum, potassium, lithium, nickel, cobalt, manganese, and other metal-containing anions.

Ionic liquids may also be synthesized by salt metathesis, by an acid-base neutralization reaction or by quaternizing a selected nitrogen-containing compound; or they may be obtained commercially from several companies such as Merck (Darmstadt, Germany) or BASF (Mount Olive, N.J.).

Representative examples of ionic liquids useful herein are included among those that are described in sources such as J. Chem. Tech. Biotechnol., 68:351-356 (1997); Chem. Ind., 68:249-263 (1996); J. Phys. Condensed Matter, 5: (supp 34B):B99-B106 (1993); Chemical and Engineering News, Mar. 30, 1998, 32-37; J. Mater. Chem., 8:2627-2636 (1998); Chem. Rev., 99:2071-2084 (1999); and WO 05/113,702 (and references therein cited). In one embodiment, a library, i.e. a combinatorial library, of ionic liquids may be prepared, for example, by preparing various alkyl derivatives of a quaternary nitrogen-containing cation, and varying the associated anions. The acidity of the ionic liquids can be adjusted by varying the molar equivalents and type and combinations of Lewis acids.

In one embodiment, ionic liquids suitable for use herein include those having cations selected from the following formulae:

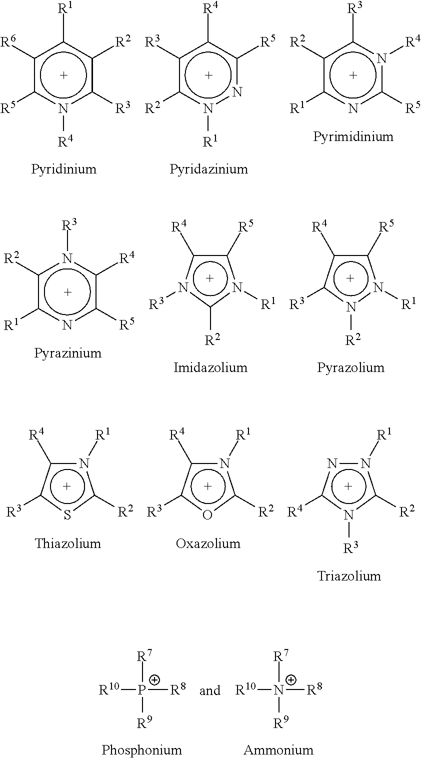

wherein R¹, R², R³, R⁴, R⁵ and R⁶ are independently selected from the group consisting of:
(i) H;
(ii) halogen;
(iii) —CH₃, —C₂H₅, or C₃ to O₂₅ straight-chain, branched or cyclic alkane or alkene, optionally substituted with at least one member selected from the group consisting of Cl, Br, F, I, OH, NH₂ and SH;
(iv) —CH₃, —C₂H₅, or C₃ to O₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(v) C₆ to O₂₀ unsubstituted aryl, or O₃ to O₂₅ unsubstituted heteroaryl having one to three heteroatoms independently selected from the group consisting of O, N, Si and S; and
(vi) C₆ to O₂₅ substituted aryl, or C₃ to O₂₅ substituted heteroaryl having one to three heteroatoms independently selected from the group consisting of O, N, Si and S; and wherein said substituted aryl or substituted heteroaryl has one to three substituents independently selected from the group consisting of:
   (1) —CH₃, —C₂H₅, or C₃ to O₂₅ straight-chain, branched or cyclic alkane or alkene, optionally substituted with at least one member selected from the group consisting of Cl, Br, F I, OH, NH₂ and SH,
   (2) OH,
   (3) NH₂, and
   (4) SH;
      and wherein R⁷, R⁸, R⁹ and R¹⁰ are independently selected from the group consisting of:
(vii) —CH₃, —C₂H₅, or C₃ to O₂₅ straight-chain, branched or cyclic alkane or alkene, optionally substituted with at least one member selected from the group consisting of Cl, Br, F, I, OH, NH₂ and SH;
(viii) —CH₃, —C₂H₅, or C₃ to O₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(ix) C₆ to O₂₅ unsubstituted aryl, or O₃ to O₂₅ unsubstituted heteroaryl having one to three heteroatoms independently selected from the group consisting of O, N, Si and S; and
(x) C₆ to O₂₅ substituted aryl, or C₃ to O₂₅ substituted heteroaryl having one to three heteroatoms independently selected from the group consisting of O, N, Si and S; and wherein said substituted aryl or substituted heteroaryl has one to three substituents independently selected from the group consisting of:
   (1) —CH₃, —C₂H₅, or C₃ to O₂₅ straight-chain, branched or cyclic alkane or alkene, optionally substituted with at least one member selected from the group consisting of Cl, Br, F, I, OH, NH₂ and SH,
   (2) OH,
   (3) NH₂, and
   (4) SH;
      and wherein, optionally, at least two of R¹, R², R³, R⁴, R⁵, R⁶, R⁷, R⁸, R⁹ and R¹⁰ together form a cyclic or bicyclic alkanyl or alkenyl group.

In another embodiment, ionic liquids useful for the invention comprise fluorinated cations wherein at least one member selected from R¹, R², R³, R⁴, R⁵, R⁶, R⁷, R⁸, R⁹ and R¹⁰ comprises F.

In another embodiment, ionic liquids useful for the invention comprise imidazolium, such as 1-ethyl-3-methylimidazolium and 1-butyl-3-methylimidazolium.

In one embodiment, ionic liquids useful herein have anions selected from the group consisting of [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]²⁻, [PO₄]³⁻, [HPO₄]²⁻, [H₂PO₄]⁻, [HSO₃]⁻, [CuCl₂]⁻, Cl⁻, Br⁻, I⁻, SCN⁻; and preferably any fluorinated anion. Fluorinated anions useful herein include [BF₄]⁻, [PF₆]⁻, [SbF₆]⁻, [CF₃SO₃]⁻, [HCF₂CF₂SO₃]⁻, [CF₃HFCCF₂SO₃]⁻, [HCClFCF₂SO₃]⁻, [(CF₃SO₂)₂N]⁻, [(CF₃CF₂SO₂)₂N]⁻, [(CF₃SO₂)₃C]⁻, [CF₃CO₂]⁻, [CF₃OCFHCF₂SO₃]⁻, [CF₃CF₂OCFHCF₂SO₃]⁻, [CF₃CFHOCF₂CF₂SO₃]⁻, [CF₂HCF₂OCF₂CF₂SO₃]⁻, [CF₂ICF₂OCF₂CF₂SO₃]⁻, [CF₃CF₂OCF₂CF₂SO₃]⁻, [(CF₂HCF₂SO₂)₂N]⁻, [(CF₃CFHCF₂SO₂)₂N]⁻; and F⁻.

In another embodiment, ionic liquids suitable for use herein may have a cation selected from the group consisting of pyridinium, pyridazinium, pyrimidinium, pyrazinium, imidazolium, pyrazolium, thiazolium, oxazolium, triazolium, phosphonium, and ammonium as defined above; and an anion selected from the group consisting of [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]²⁻, [PO₄]³⁻, [HPO₄]²⁻, [H₂PO₄]⁻, [HSO₃]⁻, [CuCl₂]⁻, Cl⁻, Br⁻, I⁻, SCN⁻, and any fluorinated anion. In yet another embodiment, ionic liquids suitable for use herein may have a cation selected from the group consisting of pyridinium, pyridazinium, pyrimidinium, pyrazinium, imidazolium, pyrazolium, thiazolium, oxazolium, triazolium, phosphonium, and ammonium as defined above; and an anion selected from the group consisting of [BF₄]⁻, [PF₆]⁻, [SbF₆]⁻, [CF₃SO₃]⁻, [HCF₂CF₂SO₃]⁻, [CF₃HFCCF₂SO₃]⁻, [HCClFCF₂SO₃]⁻, [(CF₃SO₂)₂N]⁻, [(CF₃CF₂SO₂)₂N]⁻, [(CF₃SO₂)₃C]⁻, [CF₃CO₂]⁻, [CF₃OCFHCF₂SO₃]⁻, [CF₃CF₂OCFHCF₂SO₃]⁻, [CF₃CFHOCF₂CF₂SO₃]⁻, [CF₂HCF₂OCF₂CF₂SO₃]⁻, [CF₂ICF₂OCF₂CF₂SO₃]⁻, [CF₃CF₂OCF₂CF₂SO₃]⁻, [(CF₂HCF₂SO₂)₂N]⁻, [(CF₃CFHCF₂SO₂)₂N]⁻, and F⁻.

In still another embodiment, ionic liquids suitable for use herein may have a cation selected from the group consisting of pyridinium, pyridazinium, pyrimidinium, pyrazinium, imidazolium, pyrazolium, thiazolium, oxazolium, triazolium, phosphonium, and ammonium as defined above, wherein at least one member selected from R¹, R², R³, R⁴, R⁵, R⁶, R⁷, R⁸, R⁹, and R¹⁰ comprises F⁻; and an anion selected from the group consisting of [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]²⁻, [PO₄]³⁻, [HPO₄]²⁻, [H₂PO₄]⁻, [HSO₃]⁻, [CuCl₂]⁻, Cl⁻, Br⁻, I⁻, SCN⁻, and any fluorinated anion. In still another embodiment, ionic liquids suitable for use herein may have a cation selected from the group consisting of pyridinium, pyridazinium, pyrimidinium, pyrazinium, imidazolium, pyrazolium, thiazolium, oxazolium, triazolium, phosphonium, and ammonium as defined above, wherein at least one member selected from R¹, R², R³, R⁴, R⁵, R⁶, R⁷, R⁸, R⁹, and R¹⁰ comprises F⁻; and an anion selected from the group consisting of [BF₄]⁻, [PF₆]⁻, [SbF₆]⁻, [CF₃SO₃]⁻, [HCF₂CF₂SO₃]⁻, [CF₃HFCCF₂SO₃]⁻, [HCClFCF₂SO₃]⁻, [(CF₃SO₂)₂N], [(CF₃CF₂SO₂)₂N], [(CF₃SO₂)₃C]⁻, [CF₃CO₂]⁻, [CF₃OCFHCF₂SO₃]⁻, [CF₃CF₂OCFHCF₂SO₃]⁻, [CF₃CFHOCF₂CF₂SO₃]⁻, [CF₂HCF₂OCF₂CF₂SO₃]⁻, [CF₂ICF₂OCF₂CF₂SO₃]⁻, [CF₃CF₂OCF₂CF₂SO₃]⁻, [(CF₂HCF₂SO₂)₂]⁻, [(CF₃CFHCF₂SO₂)₂N]⁻, and F⁻.

In one embodiment, the ionic liquid comprises imidazolium as the cation and [BF₄]⁻ or [PF₆]⁻ as the anion. In another embodiment, the ionic liquid comprises 1-ethyl-3-methylimidazolium (also referred to herein as Emim) or 1-butyl-3-methylimidazolium (also referred to herein as Bmim) as the cation, and [BF₄]⁻ or [PF₆]⁻ as the anion. In a particular embodiment, the ionic liquid is 1-ethyl-3-methylimidazolium tetrafluoroborate (EmimBF₄) In this embodiment, the composition of the present invention comprises CF₃I, preferably in combination with a polyalkylene glycol lubricant, such as PAG 488, sold under the trademark Ucon® PAG 488. The composition may also include tocopherol, which is a phenol which is used as a stabilizer as described below.

In some embodiments, the composition of the present invention may further comprise at least one additional compound selected from the group consisting of phenols, thiophosphates, butylated triphenylphosphorothionates, organo phosphates, phosphites, aryl alkyl ethers, terpenes, terpenoids, fullerenes, polyoxyalkylated aromatics, alkylated aromatics, epoxides, fluorinated epoxides, oxetanes, lactones, amines, alkylsilanes, benzophenone derivatives, thiols, thioethers, aryl sulfides, divinyl terephalate, diphenyl terephalate, ascorbic acid, nitromethane, and mixtures thereof, meaning mixtures of any of the compounds listed in this paragraph, and in addition, mixtures of any compound or combination of compounds listed in this paragraph with any of the ionic liquids or combination of ionic liquids as described above.

In another embodiment, the present compositions may further comprise at least one thiophosphate. Thiophosphates are compounds derived from phosphoric acids by substituting divalent sulfur for one or more oxygen atoms. Thiophosphates may be monothiophosphates, dithiophosphates or higher order thiophosphates. A representative dithiophosphate is commercially available from Ciba Specialty Chemicals of Basel, Switzerland (hereinafter “Ciba”) under the trademark Irgalube® 63. In another embodiment, thiophosphates include dialkylthiophosphate esters. A representative dialkylthiophosphate ester stabilizer is commercially available from Ciba under the trademark Irgalube® 353.

In another embodiment, the present compositions may further comprise at least one butylated triphenylphosphorothionate as depicted by Formula A.

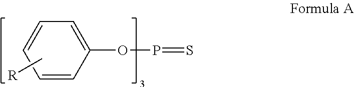

An example of a butylated triphenylphosphorothionate, wherein each R is independently selected from H or tert-butyl, is commercially available from Ciba under the trademark Irgalube® 232.

In another embodiment, the present compositions may further comprise at least one organophosphate. Organophosphates suitable for use in the present compositions include but are not limited to amine phosphates, trialkyl phosphates, triaryl phosphates, mixed alkyl-aryl phosphates (alkyldiaryl, dialkylaryl or alkylated aryl), alkylated triaryl phosphates, and cyclic phosphates, and mixtures thereof. A representative amine phosphate is commercially available from Ciba under the trademark Irgalube® 349. Representative trialkyl phosphates include: trimethyl phosphate ((CH₃)₃PO₄, Cas reg. no. 512-56-1); triethyl phosphate ((CH₃CH₂)₃PO₄, Cas reg. no. 78-40-0); tributyl phosphate ((C₄H₉)₃PO₄, CAS reg. no. 126-73-8); trioctyl phosphate ((C₈H₁₇)₃PO₄, CAS reg. no. 1806-54-8); and tri(2-ethylhexyl)phosphate ((CH₃CH(C₂H₅)(CH₂)₄)₃PO₄, CAS reg. no. 78-42-2). Representative triaryl phosphates include: triphenyl phosphate ((C₆H₅O)₃PO, CAS reg. no. 115-86-6); tricresyl phosphate (TCP, (CH₃C₆H₄O)₃PO, CAS reg. no. 1330-78-5); and trixylenyl phosphate (((CH₃)₂C₆H₃O)₃PO, CAS reg. no. 25155-23-1). Representative mixed alkyl-aryl phosphates include: isopropylphenyl phenyl phosphate (IPPP, (C₆H₅O)₂((CH₃)₂CHO)PO, CAS reg. no. 68782-95-6) and bis(t-butylphenyl)phenyl phosphate (TBPP, (C₆H₅O)₂((CH₃)₃C)PO, CAS reg. no. 65652-41-7). All of the organophosphates listed in this paragraph are available from multiple chemical suppliers such as Aldrich (Milwaukee, Wis.); Alfa Aesar (Ward Hill, Mass.); or Akzo Nobel (Arnhem, the Netherlands). The alkylated triaryl phosphates include butylated triphenyl phosphates, tert-butylated triphenyl phosphate, iso-propylated triphenyl phosphates. Representative commercially available alkylated triaryl phosphates include a butylated triphenyl phosphate, commercially available from Akzo Nobel (Arnhem, the Netherlands) under the trademark Syn-O-Ad® 8784; a tert-butylated triphenyl phosphate commercially available from Great Lakes Chemical Corporation (GLCC, West Lafayette, Ind.) under the trademark Durad® 620; and iso-propylated triphenyl phosphates, also commercially available from GLCC under the trademarks Durad® 220 and 110.

In another embodiment, the present compositions may further comprise at least one phosphite. Phosphites may comprise substituted phosphites. In particular, hindered phosphites are derivatives of alkyl, aryl or alkylaryl phosphite compounds. The hindered phosphites include tris-(di-tert-butylphenyl)phosphite, di-n-octyl phosphite, and iso-decyl diphenyl phosphite. Tris-(di-tert-butylphenyl)phosphite is sold under the trademark Irgafos® 168, di-n-octyl phosphite is sold under the trademark Irgafos®OPH, and iso-decyl diphenyl phosphite) is sold under the trademark Irgafos® DDPP, all by Ciba.

In another embodiment, the present compositions may further comprise at least one phenol. Phenols may comprise any substituted or unsubstituted phenol compound including phenols comprising one or more substituted or unsubstituted cyclic, straight chain, or branched aliphatic substituent group, such as, alkylated monophenols including 2,6-di-tert-butyl-4-methylphenol; 2,6-di-tert-butyl-4-ethylphenol; 2,4-dimethyl-6-tertbutylphenol; tocopherol; and the like, hydroquinone and alkylated hydroquinones including t-butyl hydroquinone, other derivatives of hydroquinone; and the like, hydroxylated thiodiphenyl ethers, including 4,4′-thio-bis(2-methyl-6-tert-butylphenol); 4,4′-thiobis(3-methyl-6-tertbutylphenol); 2,2′-thiobis(4-methyl-6-tert-butylphenol); and the like, alkylidene-bisphenols including: 4,4′-methylenebis(2,6-di-tert-butylphenol); 4,4′-bis(2,6-di-tert-butylphenol); derivatives of 2,2′- or 4,4-biphenoldiols; 2,2′-methylenebis(4-ethyl-6-tertbutylphenol); 2,2′-methylenebis(4-methyl-6-tertbutylphenol); 4,4-butylidenebis(3-methyl-6-tert-butylphenol); 4,4-isopropylidenebis(2,6-di-tert-butylphenol); 2,2′-methylenebis(4-methyl-6-nonylphenol); 2,2′-isobutylidenebis(4,6-dimethylphenol; 2,2′-methylenebis(4-methyl-6-cyclohexylphenol, 2,2- or 4,4-biphenyldiols including 2,2′-methylenebis(4-ethyl-6-tert-butylphenol); butylatedhydroxy toluene (BHT), bisphenols comprising heteroatoms including 2,6-di-tert-alpha-dimethylamino-p-cresol, 4,4-thiobis(6-tert-butyl-m-cresol); and the like; acylaminophenols; 2,6-di-tert-butyl-4(N,N′-dimethylaminomethylphenol); sulfides including; bis(3-methyl-4-hydroxy-5-tert-butylbenzyl)sulfide; bis(3,5-di-tert-butyl-4-hydroxybenzyl)sulfide; and mixtures thereof, meaning mixtures of any of the phenol stabilizers listed in this paragraph. In one particular embodiment, the composition of the present invention comprises CF₃I and a lubricant, preferably a polyalkylene glycol lubricant, such as PAG 488, sold under the trademark Ucon® PAG 488. This composition may be used alone, or in combination with an ionic liquid, such as 1-ethyl-3-methylimidazolium tetrafluoroborate (EmimBF₄).

In another embodiment, the present compositions may further comprise at least one terpene. Terpenes may comprise hydrocarbon compounds characterized by structures containing more than one repeating isoprene (2-methyl-1,3-butadiene) unit. Representative terpenes include but are not limited to myrcene (2-methyl-6-methyl-eneocta-1,7-diene), allo-ocimene, beta-ocimene, terebene, limonene (in particular d-limonene), retinal, pinene, menthol, geraniol, farnesol, phytol, Vitamin A, terpinene, delta-3-carene, terpinolene, phellandrene, fenchene, dipentene, and mixtures thereof, meaning mixtures of any of the terpene stabilizers listed in this paragraph. Terpene stabilizers are commercially available or may be prepared by methods known in the art or isolated from natural sources.

In another embodiment, the present compositions may further comprise at least one terpenoid. Terpenoids may comprise natural occurring substances and related compounds characterized by structures containing more than one repeating isoprene unit and usually containing oxygen. Representative terpenoids include carotenoids, such as lycopene (CAS reg. no. [502-65-8]), beta carotene (CAS reg. no. [7235-40-7]), and xanthophylls, i.e. zeaxanthin (CAS reg. no. [144-68-3]); retinoids, such as hepaxanthin (CAS reg. no. [512-39-0]), and isotretinoin (CAS reg. no. [4759-48-2]); abietane (CAS reg. no. [640-43-7]); ambrosane (CAS reg. no. [24749-18-6]); aristolane (CAS reg. no. [29788-49-6]); atisane (CAS reg. no. [24379-83-7]); beyerane (CAS reg. no. [2359-83-3]), bisabolane (CAS reg. no. [29799-19-7]); bornane (CAS reg. no. [464-15-3]); caryophyllane (CAS reg. no. [20479-00-9]); cedrane (CAS reg. no. [13567-54-9]); dammarane (CAS reg. no. [545-22-2]); drimane (CAS reg. no. [5951-58-6]); eremophilane (CAS reg. no. [3242-05-5]); eudesmane (CAS reg. no. [473-11-0]); fenchane (CAS reg. no. [6248-88-0]); gammacerane (CAS reg. no. [559-65-9]); germacrane (CAS reg. no. [645-10-3]); gibbane (CAS reg. no. [6902-95-0]); grayanotoxane (CAS reg. no. [39907-73-8]); guaiane (CAS reg. no. [489-80-5]); himachalane (CAS reg. no. [20479-45-2]); hopane (CAS reg. no. [471-62-5]); humulane (CAS reg. no. [430-19-3]); kaurane (CAS reg. no. [1573-40-6]); labdane (CAS reg. no. [561-90-0]); lanostane (CAS reg. no. [474-20-4]); lupane (CAS reg. no. [464-99-3]); p-menthane (CAS reg. no. [99-82-1]); oleanane (CAS reg. no. [471-67-0]); ophiobolane (CAS reg. no. [20098-65-1]); picrasane (CAS reg. no. [35732-97-9]); pimarane (CAS reg. no. [30257-03-5]); pinane (CAS reg. no. [473-55-2]); podocarpane (CAS reg. no. [471-78-3]); protostane (CAS reg. no. [70050-78-1]); rosane (CAS reg. no. [6812-82-4]); taxane (CAS reg. no. [1605-68-1]); thujane (CAS reg. no. [471-12-5]); trichothecane (CAS reg. no. [24706-08-9]), ursane (CAS reg. no. [464-93-7]), and mixtures thereof, meaning mixtures of any of the terpenoids listed in this paragraphs. The terpenoids of the present invention are commercially available or may be prepared by methods known in the art or may be isolated from the naturally occurring source.

In another embodiment, the present compositions may further comprise at least one fullerene. Fullerenes comprise closed carbon cages that are bonded as hexagonal carbon rings (benzene) linked to each other partly via pentagons. The relationship between the number of apices (a, carbon atoms) and hexagon carbon rings (n) (pentagon rings always number 12) is given by: a=2(n+10). While this formula provides for all theoretical structures, only those molecules with relatively low stress and distortion will be stable. Representative fullerenes include but are not limited to Buckminsterfullerene (C60, or “bucky ball”, CAS reg. no. [99685-96-8]), and [5,6]fullerene-C₇₀ (C70, CAS reg. no. [115383-22-7]), fullerene-C₇₆ (CAS reg. no. [135113-15-4]), fullerene-C₇₈ (CAS reg. no. [136316-32-0]), and fullerene-C₈₄ (CAS reg. no. [135113-16-5]), and mixtures thereof, meaning mixtures of any of the fullerenes listed in this paragraph.

In another embodiment, the present compositions may further comprise at least one aryl alkyl ether. Aryl alkyl ethers may be depicted by Formula B, wherein n is 1, 2 or 3 and R¹ is an alkyl group of 1 to 16 carbon atoms.

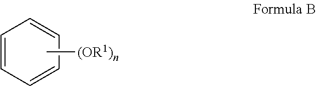

Representative aryl alkyl ethers include but are not limited to anisole, 1,4-dimethoxybenzene, 1,4-diethoxybenzene and 1,3,5-trimethoxybenzene, and mixtures thereof, meaning mixtures of any of the aryl alkyl ethers listed in the paragraph.

In another embodiment, the present compositions may further comprise at least one functionalized perfluoropolyether. Functionalized perfluoropolyethers may comprise perfluoropolyether- or perfluoroalkyl-containing and phosphorus-containing partially esterified aryl phosphates, aryl phosphonates and salts thereof, containing either (i) a mono- or poly-alkylene oxide linking group between the phosphorus and a fluorocarbon group, or (ii) no linking group between the phosphorus and fluorocarbon group as described in U.S. Pat. No. 6,184,187, and references therein. In another embodiment, the functionalized perfluoropolyethers may be compounds as represented by Formula A above, which contain either a perfluoroalkyl or perfluoropolyether side chain. In another embodiment, the functionalized perfluoropolyether stabilizers may be perfluoropolyether alkyl alcohols comprising a perfluoropolyether segment and one or more alcohols segments having a general formula, —CH₂(C_{q}H_{2q})OH, wherein —C_{q}H_{2q} represents a divalent linear or branched alkyl radical where q is an integer from 1 to about 10 as described in U.S. patent application Ser. No. 11/156,348, filed Jun. 17, 2005.

In yet another embodiment, the functionalized perfluoropolyethers of the present invention may comprise substituted aryl pnictogen compositions having the structure [R_{f}¹—(CₜR₍ᵤ₊ᵥ₎)]ₘE(O)ₙ(CₜR¹₍ᵤ₊ᵥ₊₁₎)₍₃₋ₘ₎, wherein R_{f}¹ is a fluoropolyether chain having a formula weight ranging from about 400 to about 15,000, comprises repeat units, and is selected from the group consisting of:

(a) J-O—(CF(CF₃)CF₂O)_{c}(CFXO)_{d}CFZ—;

(b) J¹-O—(CF₂CF₂O)ₑ(CF₂O)_{f}CFZ¹—;

(c) J²-O—(CF(CF₃)CF₂O)ⱼCF(CF₃)CF₂—;

(d) J³-O—(CQ₂-CF₂CF₂—P)ₖ—CQ₂-CF₂—;

(e) J³-O—(CF(CF₃)CF₂O)_{g}(CF₂CF₂O)ₕ(CFXO)ᵢ—CFZ—;

(f) J⁴-O—(CF₂CF₂O)ᵣCF₂—; and

(h) combinations of two or more thereof, wherein:

J is a fluoroalkyl group selected from the group consisting of CF₃, C₂F₅, C₃F₇, CF₂Cl, C₂F₄Cl, C₃F₆Cl, and combinations of two or more thereof;

c and d are numbers such that the ratio of c:d ranges from about 0.01 to about 0.5;

X is F, CF₃, or combinations thereof;

Z is F, C₁ or CF₃;

J¹ is a fluoroalkyl group selected from the group consisting of CF₃, C₂F₅, C₃F₇, CF₂Cl, C₂F₄Cl, and combinations of two or more thereof;

e and f are numbers such that the ratio of e:f ranges from about 0.3 to about 5;

Z¹ is F or Cl;

J² is C₂F₅, C₃F₇, or combinations thereof;

j is an average number such that the formula weight of R^{f} ranges from about 400 to about 15,000;

J³ is selected from the group consisting of CF₃, C₂F₅, C₃F₇, and combinations of two or more thereof;

k is an average number such that the formula weight of R_{f} ranges from about 400 to about 15,000;

each Q is independently F, Cl, or H;

g, h and i are numbers such that (g+h) ranges from about 1 to about 50, the ratio of i:(g+h) ranges from about 0.1 to about 0.5;

J⁴ is CF₃, C₂F₅, or combinations thereof;

r is an average number such that the formula weight of R_{f} ranges from about 400 to about 15,000; and

each R and R¹ is independently H, a C₁-C₁₀ alkyl, a halogen, OR³, OH, SO₃M, NR²₂, R³OH, R³SO₃M, R³NR²₂, R³NO₂, R³CN, C(O)OR³, C(O)OM, C(O)R³, or C(O)NR²₂, or combinations of two or more thereof;

wherein

R² is independently H, C₁-C₁₀ alkyl, or combinations of two or more thereof;

R³ is a C₁-C₁₀ alkyl; and

M is hydrogen or a metal, preferably not aluminum;

t is equal to (6+u);

u is any combination of 0, 2, 4, 6, 8, 10, 12, 14, 16;

v is independently either 2 or 4;

n is 0 or 1;

E is P, As, or Sb; and

m is greater than about 0.5 to about 3, provided that, when E=P, m=3.0 and t=6, R cannot be exclusively H or contain F; as described in U.S. patent application Ser. No. 11/167,330, filed Jun. 27, 2006.

In another embodiment, the functionalized perfluoropolyethers of the present invention may comprise aryl perfluoropolyethers, which are monofunctional aryl perfluoropolyethers having the formula of R_{f}—(Y)ₐ—(CₜR₍ᵤ₊ᵥ₎)—(O—CₜR¹₍ᵤ₊ᵥ₎)_{b}—R, difunctional aryl perfluoropolyethers having the formula of R_{f}¹—[(Y)ₐ—(CₜR₍ᵤ₊ᵥ₎—(O—CₜR¹₍ᵤ₊ᵥ₎)_{b}—R]₂, or combinations thereof, wherein

each of R_{f} and R_{f}¹ has a formula weight of about 400 to about 15,000;

R_{f} comprises repeat units selected from the group consisting of

(a) J-O—(CF(CF₃)CF₂O)_{c}(CFXO)_{d}CFZ—,

(b) J¹-O—(CF₂CF₂O)ₑ(CF₂O)_{f}CFZ¹—,

(c) J²-O—(CF(CF₃)CF₂O)ⱼCF(CF₃)—,

(d) J³-O—(CQ₂-CF₂CF₂—O)ₖ—CQ₂-,

(e) J³-O—(CF(CF₃)CF₂O)_{g}(CF₂CF₂O)ₕ(CFX—O)ᵢ—CFZ—,

(f) J⁴-O—(CF₂CF₂O)_{k′}CF₂—, and

(g) combinations of two or more thereof; and

where

the units with formulae CF₂CF₂O and CF₂O are randomly distributed along the chain;

J is CF₃, C₂F₅, C₃F₇, CF₂Cl, C₂F₄Cl, C₃F₆Cl, or combinations of two or more thereof;

c and d are numbers such that the c/d ratio ranges from about 0.01 to about 0.5;

X is —F, —CF₃, or combinations thereof;

Z is —F, —Cl or —CF₃;

Z¹ is —F or —Cl,

J¹ is CF₃, C₂F₅, C₃F₇, CF₂Cl, C₂F₄Cl, or combinations of two or more thereof;

e and f are numbers such that the e/f ratio ranges from about 0.3 to about 5;

J² is —C₂F₅, —C₃F₇, or combinations thereof;

j is an average number such that the formula weight of R_{f} ranges from about 400 to about 15,000;

J³ is CF₃, C₂F₅, C₃F₇, or combinations of two or more thereof;

k is an average number such that the formula weight of R_{f} ranges from about 400 to about 15,000;

each Q is independently —F, —Cl, or —H;

g, h and i are numbers such that (g+h) ranges from about 1 to about 50, the i/(g+h) ratio ranges from about 0.1 to about 0.5;

J⁴ is CF₃, C₂F₅, or combinations thereof;

k′ is an average number such that the formula weight of R_{f} ranges from about 400 to about 15,000;

each R is independently —H, a halogen, —OH, —SO₃M, NR³₂, —NO₂, —R⁴OH, —R⁴SO₃M, —R⁴NR³₂, —R⁴NO₂, —R⁴CN, —C(O)OR⁴, —C(O)OM, —C(O)R⁴, —C(O)NR³₂, or combinations of two or more thereof; except that when b=0, R cannot be four hydrogen atoms and —OH, or —Br, or —NH₂; or R cannot be solely H or —NO₂, or combinations thereof;

each R¹ is independently H, —R⁴, —OR⁴, a halogen, —OH, —SO₃M, —NR³₂, —NO₂, —CN, —R⁴OH, —R⁴SO₃M, —R⁴NR³₂, —R⁴NO₂, —R⁴CN, —C(O)OR⁴, —C(O)OM, —C(O)R⁴, C(O)NR³₂, or combinations of two or more thereof provided that if b=0, the combination of R and R² cannot be four or more hydrogen atoms and —OH, —Br, —NH₂, or —NO₂;

each R³ is independently H, C₁-C₁₀ alkyl, or combinations of two or more thereof;

R⁴ is a C₁-C₁₀ alkyl;

M is a hydrogen or metal ion;

a is 0 or 1;

b is 0-5;

Y is a divalent radical —CH₂OCH₂—, —(CH₂)ₒ—O—, —(CF₂)ₙ—, —CF₂O—, —CF₂OCF₂—, —C(O)—, —C(S)—, or combinations of two or more thereof;

n is about 1 to about 5;

o is about 2 to about 5;

t is equal to 6+u;

u is any combination of 0, 2, 4, 6, 8, 10, 12, 14, 16;

v is independently either 2 or 4;

Rf¹ is —(CF₂CF₂O)ₑ(CF₂O)_{f}CF₂—, —(C₃F₆O)ₚ(CF₂CF₂O)_{q}(CFXO)ᵣCF₂—,

—(CF₂CF₂O)(C₃F₆O)_{w}CF(CF₃)—, —CF(CF₃)O(C₃F₆O)_{w}—Rf²—O(C₃F₆O)_{w}CF(CF₃)—,

—((CQ₂)CF₂CF₂O)ₛCF₂CF₂—, or combinations of two or more thereof;

where

e, f, X, and Q are as defined above;

p, q and r are numbers such that (p+q) ranges from 1 to 50 and r/(p+q) ranges from 0.1 to 0.05;

each w is independently 2 to 45;

Rf² is linear or branched —CₘF₂ₘ—;
m is 1-10; and

s is an average number such that the formula weight of R_{f}¹ ranges from 400 to 15,000, as described in U.S. patent application Ser. No. 11/218,259, filed Sep. 1, 2005.

In another embodiment, the present compositions may comprise at least one polyoxyalkylated aromatic compound. In the present compositions, the substituent to the aryl group is a polyoxyalkylated group. Such compounds may be represented by Formula B, wherein the R¹ group is a polyoxyalkylated group comprising at least one —CH₂CH₂O— moiety.

In another embodiment, the present compositions may further comprise at least one alkylated aromatic. Alkylated aromatics include but are not limited to alkylbenzene lubricants, both branched and linear, commercially available under the trademarks Zerol® 75, Zerol® 150 and Zerol® (all linear alkylbenzenes) 500 from Shrieve Chemicals and HAB 22 (branched alkylbenzene) sold by Nippon Oil.

In another embodiment, the present compositions may further comprise at least one epoxide. Epoxides may comprise at least one compound selected from the group consisting of 1,2-propylene oxide (CAS reg. no. [75-56-9]), 1,2-butylene oxide (CAS reg. no. [106-88-7]), butylphenylglycidy ether, pentylphenylglycidyl ether, hexylphenylglycidyl ether, heptylphenylglycidyl ether, octylphenylglycidyl ether, nonylphenylglycidyl ether, decylphenylglycidyl ether, glycidyl methylphenylether, 1,4-glycidyl phenyl diether, 4-methoxyphenylglycidyl ether, naphthyl glycidyl ether, 1,4-diglycidyl naphthyl diether, butylphenyl glycidyl ether, n-butyl glycidyl ether, isobutyl glycidyl ether, hexanediol diglycidyl ether, allyl glycidyl ether, polypropylene glycol diglycidyl ether, and mixtures thereof, meaning mixtures of any of the foregoing epoxides listed in this paragraph.

In another embodiment, the present compositions may further comprise at least one fluorinated epoxide. The fluorinated epoxides may be depicted by Formula C, wherein each of R² through R⁵ is H, alkyl of 1 to 6 carbon atoms or fluoroalkyl of 1 to 6 carbon atoms with the proviso that at least one of R² through R⁵ is a fluoroalkyl group.

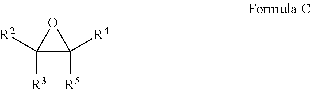

Representative fluorinated epoxides include but are not limited to trifluoromethyloxirane and 1,1-bis(trifluoromethyl)oxirane, and mixtures thereof, meaning mixtures of any of the foregoing fluorinated epoxides. Such compounds may be prepared by methods known in the art, for instance by methods described in, Journal of Fluorine Chemistry, volume 24, pages 93-104 (1984), Journal of Organic Chemistry, volume 56, pages 3187 to 3189 (1991), and Journal of Fluorine Chemistry, volume 125, pages 99-105 (2004).

In another embodiment, the present compositions may further comprise at least one oxetane. Oxetanes may be compounds with one or more oxetane groups. These compounds are represented by Formula D, wherein R₁-R₆ are the same or different and can be selected from hydrogen, alkyl or substituted alkyl, aryl or substituted aryl.

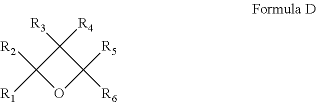

Representative oxetanes include but are not limited to 3-ethyl-3-hydroxymethyl-oxetane, such as OXT-101 (Toagosei Co., Ltd); 3-ethyl-3-((phenoxy)methyl)-oxetane, such as OXT-211 (Toagosei Co., Ltd); and 3-ethyl-3-((2-ethyl-hexyloxy)methyl)-oxetane, such as OXT-212 (Toagosei Co., Ltd), and mixtures thereof, meaning mixtures of any of the oxetanes listed in this paragraph.

In another embodiment, the present compositions may further comprise at least one lactone. Lactones comprise cyclic esters that may be produced by the reaction of an alcohol group with a carboxylic acid group in the same molecule. Representative lactones of the present invention include but are not limited to gamma-butyrolactone (CAS reg. no. [96-48-0]), delta-gluconolactone (CAS reg. no. [90-80-2]), gamma-undecalactone (CAS reg. no. [104-67-6]), 6,7-dihydro-4(5H)-benzofuranone (CAS reg. No. [16806-93-2]), and 5,7-bis(1,1-dimethylethyl)-3-[2,3(or 3,4)-dimethylphenyl]-2(3H)-benzofuranone (CAS reg. no [201815-03-4]), commercially available from Ciba under the trademark Irganox® HP-136, and mixtures thereof, meaning mixtures of any of the lactones listed in this paragraph.

In another embodiment, the present compositions may further comprise at least one amine. Amines comprise at least one compound selected from the group consisting of triethylamine, tributylamine, diisopropylamine, triisopropylamine, triisobutylamine, p-phenylenediamine, and diphenylamine. In another embodiment, the amines comprise dialkylamines including (N-(1-methylethyl)-2-propylamine, CAS reg. no. [108-18-9]). In another embodiment the amines include hindered amines. Hindered amines comprise amines derived from substituted piperidine compounds, in particular derivatives of an alkyl-substituted piperidyl, piperidinyl, piperazinone, or alkoxypiperidinyl compounds. Representative hindered amines include 2,2,6,6-tetramethyl-4-piperidone; 2,2,6,6-tetramethyl-4-piperidinol; bis-(1,2,2,6,6-pentamethylpiperidyl)sebacate (CAS reg. no. [41556-26-7]); di-(2,2,6,6-tetramethyl-4-piperidyl)sebacate, such as the hindered amine commercially available under the trademark Tinuvin® 770 by Ciba; poly-(N-hydroxyethyl-2,2,6,6-tetramethyl-4-hydroxy-piperidyl succinate (CAS reg. no. [65447-77-0]), such as that commercially available under the trademark Tinuvin® 622LD from Ciba; alkylated paraphenylenediamiens, such as N-phenyl-N′-(1,3-dimethylbutyl)-p-phenylenediamine, or N,N′-di-sec-butyl-p-phenylenediamine; and hydroxylamines such as tallow amines or N-methylbis(hydrogenated tallow alkyl)amine. Some other hindered amines include the amine antioxidant commercially available from Ciba under the trademark Tinuvin® 765, or commercially available from Mayzo, Inc. under the trademark BLS® 1944 and BLS® 1770. The amines also include mixtures of any of the amines listed in this paragraph.

In another embodiment, the present compositions may further comprise at least one alkylsilane. Alkylsilanes include but are not limited to bis(dimethylamino)methylsilane (DMAMS, CAS reg. no. [22705-33-5]), tris(trimethylsilyl)silane (TTMSS, CAS reg. no. [1873-77-4]), vinyltriethyoxysilane (VTES, CAS reg. no. [78-08-0]), and vinyltrimethoxysilane (VTMO, CAS reg. no. [2768-02-7]), and mixtures thereof, meaning mixtures of any of the alkysilanes listed in this paragraph.

In another embodiment, the present compositions may further comprise at least one benzophenone derivative. Benzophenone derivatives may comprise benzophenone substituted with side groups including halides, such as fluorine, chlorine, bromine or iodine, amino groups, hydroxyl groups, alkyl groups such as methyl, ethyl or propyl groups, aryl groups such as phenyl, nitro groups, or any combinations of such groups. Representative benzophenone derivatives include but are not limited to: 2,5-difluorobenzophenone; 2′,5′-dihydroxyacetophenone; 2-aminobenzophenone; 2-chlorobenzophenone; 2-fluorobenzophenone; 2-hydroxybenzophenone; 2-methylbenzophenone; 2-amino-4′-chlorobenzophenone; 2-amino-4′-fluorobenzophenone; 2-amino-5-bromo-2′-chlorobenzophenone; 2-amino-5-chlorobenzophenone; 2-amino-5-chloro-2′-fluorobenzophenone; 2-amino-5-nitrobenzophenone; 2-amino-5-nitro-2′-chlorobenzophenone; 2-amino-2′,5-dichlorobenzophenone; 2-chloro-4′-fluorobenzophenone; 2-hydroxy-4-methoxybenzophenone; 2-hydroxy-5-chlorobenzophenone; 2-methylamino-5-chlorobenzophenone; 3-methylbenzophenone; 3-nitrobenzophenone; 3-nitro-4′-chloro-4-fluorobenzophenone; 4-chlorobenzophenone; 4-fluorobenzophenone; 4-hydroxybenzophenone; 4-methoxybenzophenone; 4-methylbenzophenone; 4-nitrobenzophenone; 4-phenylbenzophenone; 4-chloro-3-nitrobenzophenone; 4-hydroxy-4′-chlorobenzophenone; 2,4-dihydroxybenzophenone; 2,4-dimethylbenzophenone; 2,5-dimethylbenzophenone; 3,4-diaminobenzophenone; 3,4-dichlorobenzophenone; 3,4-difluorobenzophenone; 3,4-dihydroxybenzophenone; 3,4-dimethylbenzophenone; 4,4′-bis(diethylamine)benzophenone; 4,4′-bis(dimethylamine)benzophenone; 4,4′-dichlorobenzophenone; 4,4′-difluorobenzophenone; 4,4′-dihydroxybenzophenone; and 4,4′-dimethoxybenzophenone, and mixtures thereof, meaning mixtures of any of the benzophenone derivatives listed in this paragraph.

In another embodiment, the present compositions may further comprise at least one thiol. The thiol compounds, also known as mercaptans or hydrosulfides, are the sulfur analogs of the hydroxyl group containing alcohols. Representative thiols include but are not limited to methanethiol (methyl mercaptan), ethanethiol (ethyl mercaptan), Coenzyme A (CAS reg. no. [85-61-0]), dimercaptosuccinic acid (DMSA, CAS reg. no. [2418-14-6]), grapefruit mercaptan ((R)-2-(4-methylcyclohex-3-enyl)propane-2-thiol, CAS reg. no. [83150-78-1]), cysteine ((R)-2-amino-3-sulfanyl-propanoic acid, CAS reg. no. [52-90-4]), and lipoamide (1,2-dithiolane-3-pentanamide, CAS reg. no. [940-69-2], and mixtures thereof, meaning mixtures of any of the thiols listed in this paragraph.

In another embodiment, the present compositions may further comprise at least one thioether. Thioethers include but are not limited to benzyl phenyl sulfide (CAS reg. no. [831-91-4]), diphenyl sulfide (CAS reg. no. [139-66-2]), dioctadecyl 3,3′-thiodipropionate, commercially available from Ciba under the trademark Irganox® PS 802 (Ciba) and didodecyl 3,3′-thiopropionate, commercially available from Ciba under the trademark Irganox® PS 800 (Ciba), and mixtures thereof, meaning mixtures of any of the thioethers listed in this paragraph.

In another embodiment, the present compositions may further comprise at least one aryl sulfide. The aryl sulfides comprise at least one compound selected from the group consisting of benzyl phenyl sulfide, diphenyl sulfide, and dibenzyl sulfide, and mixtures of any of the foregoing aryl sulfides.

In another embodiment, the present compositions may further comprise at least one terephthalate. The terephthalates include divinyl terephthalate (CAS reg. no. [13486-19-0]) and diphenyl terephthalate (CAS reg. no. [1539-04-4]), and mixtures of the foregoing terephthalates.

In another embodiment, the present compositions may further comprise ascorbic acid (CAS reg. no. [50-81-7]).

In another embodiment, the present compositions may further comprise nitromethane (CH₃NO₂, CAS reg. no. [75-52-5]).

In one embodiment, in the present compositions, the ionic liquids or combinations of ionic liquids with other compounds serve the purpose of stabilizing the CF₃I component of the composition. Therefore, the ionic liquid may be referred to as a stabilizer. Additionally, the combination of ionic liquid and other compounds as described previously herein may be referred to as a stabilizer blend (these combinations serve the purpose of stabilizing the CF₃I components of the compositions, as well).

In one embodiment, single ionic liquids may be combined with CF₃I. Alternatively, in another embodiment, multiple ionic liquid compounds may be combined in any proportion to serve as a stabilizer blend. A stabilizer blend may contain multiple stabilizer compounds from the same class of compounds or multiple stabilizer compounds from different classes of compounds. For example, a stabilizer blend may contain 2 or more ionic liquids, or one or more ionic liquids in combination with one or more lactones.

Additionally, some of the compounds in the present compositions exist as multiple configurational isomers or stereoisomers. Single isomers or multiple isomers of the same compound may be used in any proportion to prepare the stabilizer blend. Further, single or multiple isomers of a given compound may be combined in any proportion with any number of other compounds to serve as a stabilizer blend. The present invention is intended to include all single configurational isomers, single stereoisomers or any combination or mixture thereof.

Of particular note are compositions comprising CF₃I with combinations of compounds that provide an unexpected level of stabilization. Certain of these combinations may serve as synergistic stabilizer compositions, that is, the compositions of compounds that augment each others' efficiency in a formulation and the stabilization obtained is larger than that expected from the sum of the contributions of the individual components. Such synergistic stabilizer compositions may comprise at least one ionic liquid and any of the compounds selected from the group consisting of phenols, terpenes and terpenoids, fullerenes, epoxides, fluorination epoxides, oxetanes, divinylterephthalate, and diphenyltherephthalate, and mixtures thereof, meaning mixtures of any of the foregoing compounds in this sentence with an ionic liquid.

A limiting factor in the effectiveness of a stabilizer composition is the consumption of stabilizer and loss of functionality over the time of active use. Of particular note are synergistic stabilizer compositions comprising mixtures of stabilizers that include components capable of regenerating the consumed stabilizer during active use, hereinafter referred to as regenerative stabilizers. Unlike multi-functional single, large stabilizer compounds comprising multiple stabilizing functional groups, regenerative stabilizers comprising small “synergistic” stabilizers function with higher mobility and higher stabilization rates (meaning higher rates of reaction by which the stabilization is occurring). Regenerative stabilizer composition contains one or more stabilizers that can replenish itself or themselves after use, so that over long-term use, the composition's efficacy is maintained.

An example of a regenerative stabilizer is an ionic liquid and at least one amine. Amines for inclusion in the regenerative stabilizer compositions may comprise any of the hindered amines as described previously herein. Of particular note, are those hindered amines derived from substituted piperidine compounds, in particular derivatives of an alkyl-substituted piperidyl, piperidinyl, piperazinone, or alkoxypiperidinyl compounds, and mixtures thereof. Representative hindered amines are 2,2,6,6-tetramethyl-4-piperidone; 2,2,6,6-tetramethyl-4-piperidinol; bis-(1,2,2,6,6-pentamethylpiperidyl) sebacate (CAS reg. no. [41556-26-7]); di-(2,2,6,6-tetramethyl-4-piperidyl)sebacate, such as Tinuvin® 770; poly-(N-hydroxyethyl-2,2,6,6-tetramethyl-4-hydroxy-piperidyl succinate (CAS reg. no. [65447-77-0]), such as Tinuvin® 622LD (Ciba). Some additional hindered amines include Tinuvin® 765 (Ciba), BLS® 1944 (Mayzo, Inc.), and BLS® 1770 (Mayzo), and mixtures thereof, including mixtures of any of the hindered amines described in this paragraph.

Any suitable effective amount of stabilizer may be used in the compositions of the present invention. As described herein, the phrase “effective amount” refers to an amount of stabilizer of the present invention which, when added to a composition comprising CF₃I, results in a composition that will not degrade to produce as great a reduction in refrigeration performance when in use in a cooling apparatus as compared to the composition without stabilizer. Such effective amounts of stabilizer may be determined by way of testing under the conditions of standard test ASHRAE 97-2004. In a certain embodiment of the present invention, an effective amount may be said to be that amount of stabilizer that when combined with a composition comprising at least one fluoroolefin allows a cooling apparatus utilizing said composition comprising at least one fluoroolefin to perform at the same level of refrigeration performance and cooling capacity as if a composition comprising 1,1,1,2-tetrafluoroethane (R-134a), or other standard refrigerant (R-12, R-22, R-502, R-507A, R-508, R401A, R401B, R402A, R402B, R408, R-410A, R-404A, R407C, R-413A, R-417A, R-422A, R-422B, R-422C, R-422D, R-423, R-114, R-11, R-113, R-123, R-124, R236fa, or R-245fa) depending upon what refrigerant may have been used in a similar system in the past, were being utilized as the working fluid.

Certain embodiments include effective amounts of stabilizer for use in the present invention that comprise from about 0.001 weight percent to about 10 weight percent, more preferably from about 0.01 weight percent to about 5 weight percent, even more preferably from about 0.3 weight percent to about 4 weight percent and even more preferably from about 0.3 weight percent to about 1 weight percent based on the total weight of compositions comprising at least one fluoroolefin as described herein. When a mixture of stabilizers or stabilizer blend is used, the total amount of the mixture or stabilizer blend may be present in the concentrations as described herein above for a single stabilizer compound.

In another embodiment, the composition of the present invention as described above herein may further comprise at least one metal deactivator selected from the group consisting of areoxalyl bis(benzylidene)hydrazide (CAS reg. no. 6629-10-3); N,N′-bis(3,5-di-tert-butyl-4-hydroxyhydrocinnamoylhydrazine) (CAS reg. no. 32687-78-8); 2,2′-oxamidobis-ethyl-(3,5-d-tert-butyl-4-hydroxyhydrorcinnamate) (CAS reg. no. 70331-94-1); N,N′-(disalicyclidene)-1,2-propanediamine (CAS reg. no. 94-91-1); ethyenediaminetetraacetic acid (CAS reg. no. 60-00-4) and salts thereof; triazoles; benzotriazole, 2-mercaptobenzothiazole, tolutriazole derivatives, N,N-disalicylidene-1,2-diaminopropane, and mixtures thereof, meaning mixtures of any of the foregoing metal deactivators listed in this paragraph.

In another embodiment, a stabilizer composition comprises at least one ionic liquid, at least one amine, and at least one metal deactivator. The metal deactivator is selected from the group consisting of areoxalyl bis(benzylidene)hydrazide; N,N′-bis(3,5-di-tert-butyl-4-hydroxyhydrocinnamoylhydrazine); 2,2′-oxamidobis-ethyl-(3,5-d-tert-butyl-4-hydroxyhydrorcinnamate); N,N′-(disalicyclidene)-1,2-propanediamine; ethyenediaminetetraacetic acid and salts thereof; triazoles; benzotriazole, 2-mercaptobenzothiazole, tolutriazole derivatives, N,N-disalicylidene-1,2-diaminopropane, and mixtures thereof, meaning mixtures of any of the foregoing metal deactivators listed in this paragraph.

In another embodiment, a stabilizer composition comprises at least one ionic liquid; at least one compound selected from the group consisting of epoxides, oxetanes, lactones, divinyl terephthalate, and diphenyl terephthalate; and at least one metal deactivator selected from the group consisting of areoxalyl bis(benzylidene)hydrazide; N,N′-bis(3,5-di-tert-butyl-4-hydroxyhydrocinnamoylhydrazine); 2,2′-oxamidobis-ethyl-(3,5-d-tert-butyl-4-hydroxyhydrorcinnamate); N,N′-(disalicyclidene)-1,2-propanediamine; ethyenediaminetetraacetic acid and salts thereof; triazoles; benzotriazole, 2-mercaptobenzothiazole, tolutriazole derivatives, N,N-disalicylidene-1,2-diaminopropane, and mixtures thereof.

In one embodiment, the compositions of the present invention may further comprise at least one additional compound selected from the group consisting of fluoroolefins, hydrofluorocarbons, hydrocarbons, dimethyl ether, CF₃I, ammonia, carbon dioxide (CO₂) and mixtures thereof, meaning mixtures of any of the additional compounds listed in this paragraph.

In one embodiment, the compositions may further comprise at least one fluoroolefin. In some embodiments, fluoroolefins are compounds which comprise carbon atoms, fluorine atoms and optionally hydrogen atoms and at least one carbon to carbon double bond. In one embodiment, the fluoroolefins used in the compositions of the present invention comprise compounds with 2 to 12 carbon atoms. In another embodiment the fluoroolefins comprise compounds 3 to 10 carbon atoms, and in yet another embodiment the fluoroolefins comprise compounds 3 to 7 carbon atoms. Representative fluoroolefins include but are not limited to all compounds as listed in Table 1, Table 2, and Table 3.

In one embodiment, fluoroolefins have the formula E- or Z—R¹CH═CHR² (Formula I), wherein R¹ and R² are, independently, C₁ to O₆ perfluoroalkyl groups. Examples of R¹ and R² groups include, but are not limited to, CF₃, C₂F₅, CF₂CF₂CF₃, CF(CF₃)₂, CF₂CF₂CF₂CF₃, CF(CF₃)CF₂CF₃, CF₂CF(CF₃)₂, C(CF₃)₃, CF₂CF₂CF₂CF₂CF₃, CF₂CF₂CF(CF₃)₂, C(CF₃)₂C₂F₅, CF₂CF₂CF₂CF₂CF₂CF₃, CF(CF₃) CF₂CF₂C₂F₅, and C(CF₃)₂CF₂C₂F₅. In one embodiment, the fluoroolefins of Formula I have at least about 4 carbon atoms in the molecule. In another embodiment, the fluoroolefins of Formula I have at least about 5 carbon atoms in the molecule. Exemplary, non-limiting Formula I compounds are presented in Table 1.

TABLE 1

| Code | Structure | Chemical Name |
|---|---|---|
| F11E | CF₃CH═CHCF₃ | 1,1,1,4,4,4-hexafluorobut-2-ene |
| F12E | CF₃CH═CHC₂F₅ | 1,1,1,4,4,5,5,5-octafluoropent-2-ene |
| F13E | CF₃CH═CHCF₂C₂F₅ | 1,1,1,4,4,5,5,6,6,6-decafluorohex-2-ene |
| F13iE | CF₃CH═CHCF(CF₃)₂ | 1,1,1,4,5,5,5-heptafluoro-4-(trifluoromethyl)pent-2-ene |
| F22E | C₂F₅CH═CHC₂F₅ | 1,1,1,2,2,5,5,6,6,6-decafluorohex-3-ene |
| F14E | CF₃CH═CH(CF₂)₃CF₃ | 1,1,1,4,4,5,5,6,6,7,7,7-dodecafluorohept-2-ene |
| F14iE | CF₃CH═CHCF₂CF—(CF₃)₂ | 1,1,1,4,4,5,6,6,6-nonafluoro-5-(trifluoromethyl)hex-2-ene |
| F14sE | CF₃CH═CHCF(CF₃)—C₂F₅ | 1,1,1,4,5,5,6,6,6-nonfluoro-4-(trifluoromethyl)hex-2-ene |
| F14tE | CF₃CH═CHC(CF₃)₃ | 1,1,1,5,5,5-hexafluoro-4,4-bis(trifluoromethyl)pent-2-ene |
| F23E | C₂F₅CH═CHCF₂C₂F₅ | 1,1,1,2,2,5,5,6,6,7,7,7-dodecafluorohept-3-ene |
| F23iE | C₂F₅CH═CHCF(CF₃)₂ | 1,1,1,2,2,5,6,6,6-nonafluoro-5-(trifluoromethyl)hex-3-ene |
| F15E | CF₃CH═CH(CF₂)₄CF₃ | 1,1,1,4,4,5,5,6,6,7,7,8,8,8-tetradecafluorooct-2-ene |
| F15iE | CF₃CH═CH—CF₂CF₂CF(CF₃)₂ | 1,1,1,4,4,5,5,6,7,7,7-undecafluoro-6-(trifluoromethyl)hept- |
| | | 2-ene |
| F15tE | CF₃CH═CH—C(CF₃)₂C₂F₅ | 1,1,1,5,5,6,6,6-octafluoro-4,4-bis(trifluoromethyl)hex-2- |
| | | ene |
| F24E | C₂F₅CH═CH(CF₂)₃CF₃ | 1,1,1,2,2,5,5,6,6,7,7,8,8,8-tetradecafluorooct-3-ene |
| F24iE | C₂F₅CH═CHCF₂CF—(CF₃)₂ | 1,1,1,2,2,5,5,6,7,7,7-undecafluoro-6-(trifluoromethyl)hept- |
| | | 3-ene |
| F24sE | C₂F₅CH═CHCF(CF₃)—C₂F₅ | 1,1,1,2,2,5,6,6,7,7,7-undecafluoro-5-(trifluoromethyl)hept- |
| | | 3-ene |
| F24tE | C₂F₅CH═CHC(CF₃)₃ | 1,1,1,2,2,6,6,6-octafluoro-5,5-bis(trifluoromethyl)hex-3- |
| | | ene |
| F33E | C₂F₅CF₂CH═CH—CF₂C₂F₅ | 1,1,1,2,2,3,3,6,6,7,7,8,8,8-tetradecafluorooct-4-ene |
| F3i3iE | (CF₃)₂CFCH═CH—CF(CF₃)₂ | 1,1,1,2,5,6,6,6-octafluoro-2,5-bis(trifluoromethyl)hex-3- |
| | | ene |
| F33iE | C₂F₅CF₂CH═CH—CF(CF₃)₂ | 1,1,1,2,5,5,6,6,7,7,7-undecafluoro-2-(trifluoromethyl)hept- |
| | | 3-ene |
| F16E | CF₃CH═CH(CF₂)₅CF₃ | 1,1,1,4,4,5,5,6,6,7,7,8,8,,9,9,9-hexadecafluoronon-2-ene |
| F16sE | CF₃CH═CHCF(CF₃)(CF₂)₂C₂F₅ | 1,1,1,4,5,5,6,6,7,7,8,8,8-tridecafluoro-4- |
| | | (trifluoromethyl)hept-2-ene |
| F16tE | CF₃CH═CHC(CF₃)₂CF₂C₂F₅ | 1,1,1,6,6,6-octafluoro-4,4-bis(trifluoromethyl)hept-2-ene |
| F25E | C₂F₅CH═CH(CF₂)₄CF₃ | 1,1,1,2,2,5,5,6,6,7,7,8,8,9,9,9-hexadecafluoronon-3-ene |
| F25iE | C₂F₅CH═CH—CF₂CF₂CF(CF₃)₂ | 1,1,1,2,2,5,5,6,6,7,8,8,8-tridecafluoro-7- |
| | | (trifluoromethyl)oct-3-ene |
| F25tE | C₂F₅CH═CH—C(CF₃)₂C₂F₅ | 1,1,1,2,2,6,6,7,7,7-decafluoro-5,5- |
| | | bis(trifluoromethyl)hept-3-ene |
| F34E | C₂F₅CF₂CH═CH—(CF₂)₃CF₃ | 1,1,1,2,2,3,3,6,6,7,7,8,8,9,9,9-hexadecafluoronon-4-ene |
| F34iE | C₂F₅CF₂CH═CH—CF₂CF(CF₃)₂ | 1,1,1,2,2,3,3,6,6,7,8,8,8-tridecafluoro-7- |
| | | (trifluoromethyl)oct-4-ene |
| F34sE | C₂F₅CF₂CH═CH—CF(CF₃)C₂F₅ | 1,1,1,2,2,3,3,6,7,7,8,8,8-tridecafluoro-6- |
| | | (trifluoromethyl)oct-4-ene |
| F34tE | C₂F₅CF₂CH═CH—C(CF₃)₃ | 1,1,1,5,5,6,6,7,7,7-decafluoro-2,2- |
| | | bis(trifluoromethyl)hept-3-ene |
| F3i4E | (CF₃)₂CFCH═CH—(CF₂)₃CF₃ | 1,1,1,2,5,5,6,6,7,7,8,8,8-tridecafluoro- |
| | | 2(trifluoromethyl)oct-3-ene |
| F3i4iE | (CF₃)₂CFCH═CH—CF₂CF(CF₃)₂ | 1,1,1,2,5,5,6,7,7,7-decafluoro-2,6- |
| | | bis(trifluoromethyl)hept-3-ene |
| F3i4sE | (CF₃)₂CFCH═CH—CF(CF₃)C₂F₅ | 1,1,1,2,5,6,6,7,7,7-decafluoro-2,5- |
| | | bis(trifluoromethyl)hept-3-ene |
| F3i4tE | (CF₃)₂CFCH═CH—C(CF₃)₃ | 1,1,1,2,6,6,6-heptafluoro-2,5,5-tris(trifluoromethyl)hex-3- |
| | | ene |
| F26E | C₂F₅CH═CH(CF₂)₅CF₃ | 1,1,1,2,2,5,5,6,6,7,7,8,8,9,9,10,10,10-octadecafluorodec- |
| | | 3-ene |
| F26sE | C₂F₅CH═CHCF(CF₃)(CF₂)₂C₂F₅ | 1,1,1,2,2,5,6,6,7,7,8,8,9,9,9-pentadecafluoro-5- |
| | | (trifluoromethyl)non-3-ene |
| F26tE | C₂F₅CH═CHC(CF₃)₂CF₂C₂F₅ | 1,1,1,2,2,6,6,7,7,8,8,8-dodecafluoro-5,5- |
| | | bis(trifluoromethyl)oct-3-ene |
| F35E | C₂F₅CF₂CH═CH—(CF₂)₄CF₃ | 1,1,1,2,2,3,3,6,6,7,7,8,8,9,9,10,10,10-octadecafluorodec- |
| | | 4-ene |
| F35iE | C₂F₅CF₂CH═CH—CF₂CF₂CF(CF₃)₂ | 1,1,1,2,2,3,3,6,6,7,7,8,9,9,9-pentadecafluoro-8- |
| | | (trifluoromethyl)non-4-ene |
| F35tE | C₂F₅CF₂CH═CH—C(CF₃)₂C₂F₅ | 1,1,1,2,2,3,3,7,7,8,8,8-dodecafluoro-6,6- |
| | | bis(trifluoromethyl)oct-4-ene |
| F3i5E | (CF₃)₂CFCH═CH—(CF₂)₄CF₃ | 1,1,1,2,5,5,6,6,7,7,8,8,9,9,9-pentadecafluoro-2- |
| | | (trifluoromethyl)non-3-ene |
| F3i5iE | (CF₃)₂CFCH═CH—CF₂CF₂CF(CF₃)₂ | 1,1,1,2,5,5,6,6,7,8,8,8-dodecafluoro-2,7- |
| | | bis(trifluoromethyl)oct-3-ene |
| F3i5tE | (CF₃)₂CFCH═CH—C(CF₃)₂C₂F₅ | 1,1,1,2,6,6,7,7,7-nonafluoro-2,5,5- |
| | | tris(trifluoromethyl)hept-3-ene |
| F44E | CF₃(CF₂)₃CH═CH—(CF₂)₃CF₃ | 1,1,1,2,2,3,3,4,4,7,7,8,8,9,9,10,10,10-octadecafluorodec- |
| | | 5-ene |
| F44iE | CF₃(CF₂)₃CH═CH—CF₂CF(CF₃)₂ | 1,1,1,2,3,3,6,6,7,7,8,8,9,9,9-pentadecafluoro-2- |
| | | (trifluoromethyl)non-4-ene |
| F44sE | CF₃(CF₂)₃CH═CH—CF(CF₃)C₂F₅ | 1,1,1,2,2,3,6,6,7,7,8,8,9,9,9-pentadecafluoro-3- |
| | | (trifluoromethyl)non-4-ene |
| F44tE | CF₃(CF₂)₃CH═CH—C(CF₃)₃ | 1,1,1,5,5,6,6,7,7,8,8,8-dodecafluoro-2,2,- |
| | | bis(trifluoromethyl)oct-3-ene |
| F4i4iE | (CF₃)₂CFCF₂CH═CH—CF₂CF(CF₃)₂ | 1,1,1,2,3,3,6,6,7,8,8,8-dodecafluoro-2,7- |
| | | bis(trifluoromethyl)oct-4-ene |
| F4i4sE | (CF₃)₂CFCF₂CH═CH—CF(CF₃)C₂F₅ | 1,1,1,2,3,3,6,7,7,8,8,8-dodecafluoro-2,6- |
| | | bis(trifluoromethyl)oct-4-ene |
| F4i4tE | (CF₃)₂CFCF₂CH═CH—C(CF₃)₃ | 1,1,1,5,5,6,7,7,7-nonafluoro-2,2,6- |
| | | tris(trifluoromethyl)hept-3-ene |
| F4s4sE | C₂F₅CF(CF₃)CH═CH—CF(CF₃)C₂F₅ | 1,1,1,2,2,3,6,7,7,8,8,8-dodecafluoro-3,6- |
| | | bis(trifluoromethyl)oct-4-ene |
| F4s4tE | C₂F₅CF(CF₃)CH═CH—C(CF₃)₃ | 1,1,1,5,6,6,7,7,7-nonafluoro-2,2,5- |
| | | tris(trifluoromethyl)hept-3-ene |
| F4t4tE | (CF₃)₃CCH═CH—C(CF₃)₃ | 1,1,1,6,6,6-hexafluoro-2,2,5,5- |
| | | tetrakis(trifluoromethyl)hex-3-ene |

Compounds of Formula I may be prepared by contacting a perfluoroalkyl iodide of the formula R¹I with a perfluoroalkyltrihydroolefin of the formula R²CH═CH₂ to form a trihydroiodoperfluoroalkane of the formula R¹CH₂CHIR². This trihydroiodoperfluoroalkane can then be dehydroiodinated to form R¹CH═CHR². Alternatively, the olefin R¹CH═CHR² may be prepared by dehydroiodination of a trihydroiodoperfluoroalkane of the formula R¹CHICH₂R² formed in turn by reacting a perfluoroalkyl iodide of the formula R²I with a perfluoroalkyltrihydroolefin of the formula R¹CH═CH₂.

The contacting of a perfluoroalkyl iodide with a perfluoroalkyltrihydroolefin may take place in batch mode by combining the reactants in a suitable reaction vessel capable of operating under the autogenous pressure of the reactants and products at reaction temperature. Suitable reaction vessels include fabricated from stainless steels, in particular of the austenitic type, and the well-known high nickel alloys such as Monel® nickel-copper alloys, Hastelloy® nickel based alloys and Inconel® nickel-chromium alloys.

Alternatively, the reaction may take be conducted in semi-batch mode in which the perfluoroalkyltrihydroolefin reactant is added to the perfluoroalkyl iodide reactant by means of a suitable addition apparatus such as a pump at the reaction temperature.

The ratio of perfluoroalkyl iodide to perfluoroalkyltrihydroolefin should be between about 1:1 to about 4:1, preferably from about 1.5:1 to 2.5:1. Ratios less than 1.5:1 tend to result in large amounts of the 2:1 adduct as reported by Jeanneaux, et. al. in Journal of Fluorine Chemistry, Vol. 4, pages 261-270 (1974).

Preferred temperatures for contacting of said perfluoroalkyl iodide with said perfluoroalkyltrihydroolefin are preferably within the range of about 150° C. to 300° C., preferably from about 170° C. to about 250° C., and most preferably from about 180° C. to about 230° C.

Suitable contact times for the reaction of the perfluoroalkyl iodide with the perfluoroalkyltrihydroolefin are from about 0.5 hour to 18 hours, preferably from about 4 to about 12 hours.

The trihydroiodoperfluoroalkane prepared by reaction of the perfluoroalkyl iodide with the perfluoroalkyltrihydroolefin may be used directly in the dehydroiodination step or may preferably be recovered and purified by distillation prior to the dehydroiodination step.

The dehydroiodination step is carried out by contacting the trihydroiodoperfluoroalkane with a basic substance. Suitable basic substances include alkali metal hydroxides (e.g., sodium hydroxide or potassium hydroxide), alkali metal oxide (for example, sodium oxide), alkaline earth metal hydroxides (e.g., calcium hydroxide), alkaline earth metal oxides (e.g., calcium oxide), alkali metal alkoxides (e.g., sodium methoxide or sodium ethoxide), aqueous ammonia, sodium amide, or mixtures of basic substances such as soda lime. Preferred basic substances are sodium hydroxide and potassium hydroxide.

Said contacting of the trihydroiodoperfluoroalkane with a basic substance may take place in the liquid phase preferably in the presence of a solvent capable of dissolving at least a portion of both reactants. Solvents suitable for the dehydroiodination step include one or more polar organic solvents such as alcohols (e.g., methanol, ethanol, n-propanol, isopropanol, n-butanol, isobutanol, and tertiary butanol), nitriles (e.g., acetonitrile, propionitrile, butyronitrile, benzonitrile, or adiponitrile), dimethyl sulfoxide, N,N-dimethylformamide, N,N-dimethylacetamide, or sulfolane. The choice of solvent may depend on the boiling point product and the ease of separation of traces of the solvent from the product during purification. Typically, ethanol or isopropanol are good solvents for the reaction.

Typically, the dehydroiodination reaction may be carried out by addition of one of the reactants (either the basic substance or the trihydroiodoperfluoroalkane) to the other reactant in a suitable reaction vessel. Said reaction may be fabricated from glass, ceramic, or metal and is preferably agitated with an impeller or stirring mechanism.

Temperatures suitable for the dehydroiodination reaction are from about 10° C. to about 100° C., preferably from about 20° C. to about 70° C. The dehydroiodination reaction may be carried out at ambient pressure or at reduced or elevated pressure. Of note are dehydroiodination reactions in which the compound of Formula I is distilled out of the reaction vessel as it is formed.

Alternatively, the dehydroiodination reaction may be conducted by contacting an aqueous solution of said basic substance with a solution of the trihydroiodoperfluoroalkane in one or more organic solvents of lower polarity such as an alkane (e.g., hexane, heptane, or octane), aromatic hydrocarbon (e.g., toluene), halogenated hydrocarbon (e.g., methylene chloride, chloroform, carbon tetrachloride, or perchloroethylene), or ether (e.g., diethyl ether, methyl tert-butyl ether, tetrahydrofuran, 2-methyl tetrahydrofuran, dioxane, dimethoxyethane, diglyme, or tetraglyme) in the presence of a phase transfer catalyst. Suitable phase transfer catalysts include quaternary ammonium halides (e.g., tetrabutylammonium bromide, tetrabutylammonium hydrosulfate, triethylbenzylammonium chloride, dodecyltrimethylammonium chloride, and tricaprylylmethylammonium chloride), quaternary phosphonium halides (e.g., triphenylmethylphosphonium bromide and tetraphenylphosphonium chloride), or cyclic polyether compounds known in the art as crown ethers (e.g., 18-crown-6 and 15-crown-5).

Alternatively, the dehydroiodination reaction may be conducted in the absence of solvent by adding the trihydroiodoperfluoroalkane to a solid or liquid basic substance.

Suitable reaction times for the dehydroiodination reactions are from about 15 minutes to about six hours or more depending on the solubility of the reactants. Typically the dehydroiodination reaction is rapid and requires about 30 minutes to about three hours for completion. The compound of Formula I may be recovered from the dehydroiodination reaction mixture by phase separation after addition of water, by distillation, or by a combination thereof.

In another embodiment, fluoroolefins comprise cyclic fluoroolefins (cyclo-[CX═CY(CZW)ₙ—] (Formula II), wherein X, Y, Z, and W are independently selected from H and F, and n is an integer from 2 to 5). In one embodiment, the fluoroolefins of Formula II, have at least about 4 carbon atoms in the molecule. In yet another embodiment, the fluoroolefins of Formula II have at least about 5 carbon atoms in the molecule. Representative cyclic fluoroolefins of Formula II are listed in Table 2.

TABLE 2

| Cyclic | | |
|---|---|---|
| fluoroolefins | Structure | Chemical name |
| FC-C1316cc | cyclo-CF₂CF₂CF═CF— | 1,2,3,3,4,4- |
| | | hexafluorocyclobutene |
| HFC-C1334cc | cyclo-CF₂CF₂CH═CH— | 3,3,4,4- |
| | | tetrafluorocyclobutene |
| HFC-C1436 | cyclo-CF₂CF₂CF₂CH═CH— | 3,3,4,4,5,5,- |
| | | hexafluorocyclopentene |
| FC-C1418y | cyclo-CF₂CF═CFCF₂CF₂— | 1,2,3,3,4,4,5,5- |
| | | octafluorocyclopentene |
| FC-C151-10y | cyclo- | 1,2,3,3,4,4,5,5,6,6- |
| | CF₂CF═CFCF₂CF₂CF₂— | decafluorocyclohexene |

In another embodiment, fluoroolefins may comprise those compounds listed in Table 3.

TABLE 3

| Name | Structure | Chemical name |
|---|---|---|
| HFC-1225ye | CF₃CF═CHF | 1,2,3,3,3-pentafluoro-1-propene |
| HFC-1225zc | CF₃CH═CF₂ | 1,1,3,3,3-pentafluoro-1-propene |
| HFC-1225yc | CHF₂CF═CF₂ | 1,1,2,3,3-pentafluoro-1-propene |
| HFC-1234ye | CHF₂CF═CHF | 1,2,3,3-tetrafluoro-1-propene |
| HFC-1234yf | CF₃CF═CH₂ | 2,3,3,3-tetrafluoro-1-propene |
| HFC-1234ze | CF₃CH═CHF | 1,3,3,3-tetrafluoro-1-propene |
| HFC-1234yc | CH₂FCF═CF₂ | 1,1,2,3-tetrafluoro-1-propene |
| HFC-1234zc | CHF₂CH═CF₂ | 1,1,3,3-tetrafluoro-1-propene |
| HFC-1243yf | CHF₂CF═CH₂ | 2,3,3-trifluoro-1-propene |
| HFC-1243zf | CF₃CH═CH₂ | 3,3,3-trifluoro-1-propene |
| HFC-1243yc | CH₃CF═CF₂ | 1,1,2-trifluoro-1-propene |
| HFC-1243zc | CH₂FCH═CF₂ | 1,1,3-trifluoro-1-propene |
| HFC-1243ye | CH₂FCF═CHF | 1,2,3-trifluoro-1-propene |
| HFC-1243ze | CHF₂CH═CHF | 1,3,3-trifluoro-1-propene |
| FC-1318my | CF₃CF═CFCF₃ | 1,1,1,2,3,4,4,4-octafluoro-2-butene |
| FC-1318cy | CF₃CF₂CF═CF₂ | 1,1,2,3,3,4,4,4-octafluoro-1-butene |
| HFC-1327my | CF₃CF═CHCF₃ | 1,1,1,2,4,4,4-heptafluoro-2-butene |
| HFC-1327ye | CHF═CFCF₂CF₃ | 1,2,3,3,4,4,4-heptafluoro-1-butene |
| HFC-1327py | CHF₂CF═CFCF₃ | 1,1,1,2,3,4,4-heptafluoro-2-butene |
| HFC-1327et | (CF₃)₂C═CHF | 1,3,3,3-tetrafluoro-2- |
| | | (trifluoromethyl)-1-propene |
| HFC-1327cz | CF₂═CHCF₂CF₃ | 1,1,3,3,4,4,4-heptafluoro-1-butene |
| HFC-1327cye | CF₂═CFCHFCF₃ | 1,1,2,3,4,4,4-heptafluoro-1-butene |
| HFC-1327cyc | CF₂═CFCF₂CHF₂ | 1,1,2,3,3,4,4-heptafluoro-1-butene |
| HFC-1336yf | CF₃CF₂CF═CH₂ | 2,3,3,4,4,4-hexafluoro-1-butene |
| HFC-1336ze | CHF═CHCF₂CF₃ | 1,3,3,4,4,4-hexafluoro-1-butene |
| HFC-1336eye | CHF═CFCHFCF₃ | 1,2,3,4,4,4-hexafluoro-1-butene |
| HFC-1336eyc | CHF═CFCF₂CHF₂ | 1,2,3,3,4,4-hexafluoro-1-butene |
| HFC-1336pyy | CHF₂CF═CFCHF₂ | 1,1,2,3,4,4-hexafluoro-2-butene |
| HFC-1336qy | CH₂FCF═CFCF₃ | 1,1,1,2,3,4-hexafluoro-2-butene |
| HFC-1336pz | CHF₂CH═CFCF₃ | 1,1,1,2,4,4-hexafluoro-2-butene |
| HFC-1336mzy | CF₃CH═CFCHF₂ | 1,1,1,3,4,4-hexafluoro-2-butene |
| HFC-1336qc | CF₂═CFCF₂CH₂F | 1,1,2,3,3,4-hexafluoro-1-butene |
| HFC-1336pe | CF₂═CFCHFCHF₂ | 1,1,2,3,4,4-hexafluoro-1-butene |
| HFC-1336ft | CH₂═C(CF₃)₂ | 3,3,3-trifluoro-2-(trifluoromethyl)-1- |
| | | propene |
| HFC-1345qz | CH₂FCH═CFCF₃ | 1,1,1,2,4-pentafluoro-2-butene |
| HFC-1345mzy | CF₃CH═CFCH₂F | 1,1,1,3,4-pentafluoro-2-butene |
| HFC-1345fz | CF₃CF₂CH═CH₂ | 3,3,4,4,4-pentafluoro-1-butene |
| HFC-1345mzz | CHF₂CH═CHCF₃ | 1,1,1,4,4-pentafluoro-2-butene |
| HFC-1345sy | CH₃CF═CFCF₃ | 1,1,1,2,3-pentafluoro-2-butene |
| HFC-1345fyc | CH₂═CFCF₂CHF₂ | 2,3,3,4,4-pentafluoro-1-butene |
| HFC-1345pyz | CHF₂CF═CHCHF₂ | 1,1,2,4,4-pentafluoro-2-butene |
| HFC-1345cyc | CH₃CF₂CF═CF₂ | 1,1,2,3,3-pentafluoro-1-butene |
| HFC-1345pyy | CH₂FCF═CFCHF₂ | 1,1,2,3,4-pentafluoro-2-butene |
| HFC-1345eyc | CH₂FCF₂CF═CHF | 1,2,3,3,4-pentafluoro-1-butene |
| HFC-1345ctm | CF₂═C(CF₃)(CH₃) | 1,1,3,3,3-pentafluoro-2-methyl-1- |
| | | propene |
| HFC-1345ftp | CH₂═C(CHF₂)(CF₃) | 2-(difluoromethyl)-3,3,3-trifluoro-1- |
| | | propene |
| HFC1345fye | CH₂═CFCHFCF₃ | 2,3,4,4,4-pentafluoro-1-butene |
| HFC-1345eyf | CHF═CFCH₂CF₃ | 1,2,4,4,4-pentafluoro-1-butene |
| HFC-1345eze | CHF═CHCHFCF₃ | 1,3,4,4,4-pentafluoro-1-butene |
| HFC-1345ezc | CHF═CHCF₂CHF₂ | 1,3,3,4,4-pentafluoro-1-butene |
| HFC-1345eye | CHF═CFCHFCHF₂ | 1,2,3,4,4-pentafluoro-1-butene |
| HFC-1354fzc | CH₂═CHCF₂CHF₂ | 3,3,4,4-tetrafluoro-1-butene |
| HFC-1354ctp | CF₂═C(CHF₂)(CH₃) | 1,1,3,3-tetrafluoro-2-methyl-1- |
| | | propene |
| HFC-1354etm | CHF═C(CF₃)(CH₃) | 1,3,3,3-tetrafluoro-2-methyl-1- |
| | | propene |
| HFC-1354tfp | CH₂═C(CHF₂)₂ | 2-(difluoromethyl)-3,3-difluoro-1- |
| | | propene |
| HFC-1354my | CF₃CF═CHCH₃ | 1,1,1,2-tetrafluoro-2-butene |
| HFC-1354mzy | CH₃CF═CHCF₃ | 1,1,1,3-tetrafluoro-2-butene |
| FC-141-10myy | CF₃CF═CFCF₂CF₃ | 1,1,1,2,3,4,4,5,5,5-decafluoro-2- |
| | | pentene |
| FC-141-10cy | CF₂═CFCF₂CF₂CF₃ | 1,1,2,3,3,4,4,5,5,5-decafluoro-1- |
| | | pentene |
| HFC-1429mzt | (CF₃)₂C═CHCF₃ | 1,1,1,4,4,4-hexafluoro-2- |
| | | (trifluoromethyl)-2-butene |
| HFC-1429myz | CF₃CF═CHCF₂CF₃ | 1,1,1,2,4,4,5,5,5-nonafluoro-2- |
| | | pentene |
| HFC-1429mzy | CF₃CH═CFCF₂CF₃ | 1,1,1,3,4,4,5,5,5-nonafluoro-2- |
| | | pentene |
| HFC-1429eyc | CHF═CFCF₂CF₂CF₃ | 1,2,3,3,4,4,5,5,5-nonafluoro-1- |
| | | pentene |
| HFC-1429czc | CF₂═CHCF₂CF₂CF₃ | 1,1,3,3,4,4,5,5,5-nonafluoro-1- |
| | | pentene |
| HFC-1429cycc | CF₂═CFCF₂CF₂CHF₂ | 1,1,2,3,3,4,4,5,5-nonafluoro-1- |
| | | pentene |
| HFC-1429pyy | CHF₂CF═CFCF₂CF₃ | 1,1,2,3,4,4,5,5,5-nonafluoro-2- |
| | | pentene |
| HFC-1429myyc | CF₃CF═CFCF₂CHF₂ | 1,1,1,2,3,4,4,5,5-nonafluoro-2- |
| | | pentene |
| HFC-1429myye | CF₃CF═CFCHFCF₃ | 1,1,1,2,3,4,5,5,5-nonafluoro-2- |
| | | pentene |
| HFC-1429eyym | CHF═CFCF(CF₃)₂ | 1,2,3,4,4,4-hexafluoro-3- |
| | | (trifluoromethyl)-1-butene |
| HFC-1429cyzm | CF₂═CFCH(CF₃)₂ | 1,1,2,4,4,4-hexafluoro-3- |
| | | (trifluoromethyl)-1-butene |
| HFC-1429mzt | CF₃CH═C(CF₃)₂ | 1,1,1,4,4,4-hexafluoro-2- |
| | | (trifluoromethyl)-2-butene |
| HFC-1429czym | CF₂═CHCF(CF₃)₂ | 1,1,3,4,4,4-hexafluoro-3- |
| | | (trifluoromethyl)-1-butene |
| HFC-1438fy | CH₂═CFCF₂CF₂CF₃ | 2,3,3,4,4,5,5,5-octafluoro-1- |
| | | pentene |
| HFC-1438eycc | CHF═CFCF₂CF₂CHF₂ | 1,2,3,3,4,4,5,5-octafluoro-1- |
| | | pentene |
| HFC-1438ftmc | CH₂═C(CF₃)CF₂CF₃ | 3,3,4,4,4-pentafluoro-2- |
| | | (trifluoromethyl)-1-butene |
| HFC-1438czzm | CF₂═CHCH(CF₃)₂ | 1,1,4,4,4-pentafluoro-3- |
| | | (trifluoromethyl)-1-butene |
| HFC-1438ezym | CHF═CHCF(CF₃)₂ | 1,3,4,4,4-pentafluoro-3- |
| | | (trifluoromethyl)-1-butene |
| HFC-1438ctmf | CF₂═C(CF₃)CH₂CF₃ | 1,1,4,4,4-pentafluoro-2- |
| | | (trifluoromethyl)-1-butene |
| HFC-1447fzy | (CF₃)₂CFCH═CH₂ | 3,4,4,4-tetrafluoro-3- |
| | | (trifluoromethyl)-1-butene |
| HFC-1447fz | CF₃CF₂CF₂CH═CH₂ | 3,3,4,4,5,5,5-heptafluoro-1-pentene |
| HFC-1447fycc | CH₂═CFCF₂CF₂CHF₂ | 2,3,3,4,4,5,5-heptafluoro-1-pentene |
| HFC-1447czcf | CF₂═CHCF₂CH₂CF₃ | 1,1,3,3,5,5,5-heptafluoro-1-pentene |
| HFC-1447mytm | CF₃CF═C(CF₃)(CH₃) | 1,1,1,2,4,4,4-heptafluoro-3-methyl- |
| | | 2-butene |
| HFC-1447fyz | CH₂═CFCH(CF₃)₂ | 2,4,4,4-tetrafluoro-3- |
| | | (trifluoromethyl)-1-butene |
| HFC-1447ezz | CHF═CHCH(CF₃)₂ | 1,4,4,4-tetrafluoro-3- |
| | | (trifluoromethyl)-1-butene |
| HFC-1447qzt | CH₂FCH═C(CF₃)₂ | 1,4,4,4-tetrafluoro-2- |
| | | (trifluoromethyl)-2-butene |
| HFC-1447syt | CH₃CF═C(CF₃)₂ | 2,4,4,4-tetrafluoro-2- |
| | | (trifluoromethyl)-2-butene |
| HFC-1456szt | (CF₃)₂C═CHCH₃ | 3-(trifluoromethyl)-4,4,4-trifluoro-2- |
| | | butene |
| HFC-1456szy | CF₃CF₂CF═CHCH₃ | 3,4,4,5,5,5-hexafluoro-2-pentene |
| HFC-1456mstz | CF₃C(CH₃)═CHCF₃ | 1,1,1,4,4,4-hexafluoro-2-methyl-2- |
| | | butene |
| HFC-1456fzce | CH₂═CHCF₂CHFCF₃ | 3,3,4,5,5,5-hexafluoro-1-pentene |
| HFC-1456ftmf | CH₂═C(CF₃)CH₂CF₃ | 4,4,4-trifluoro-2-(trifluoromethyl)-1- |
| | | butene |
| FC-151-12c | CF₃(CF₂)₃CF═CF₂ | 1,1,2,3,3,4,4,5,5,6,6,6- |
| | | dodecafluoro-1-hexene (or |
| | | perfluoro-1-hexene) |
| FC-151-12mcy | CF₃CF₂CF═CFCF₂CF₃ | 1,1,1,2,2,3,4,5,5,6,6,6- |
| | | dodecafluoro-3-hexene (or |
| | | perfluoro-3-hexene) |
| FC-151-12mmtt | (CF₃)₂C═C(CF₃)₂ | 1,1,1,4,4,4-hexafluoro-2,3- |
| | | bis(trifluoromethyl)-2-butene |
| FC-151-12mmzz | (CF₃)₂CFCF═CFCF₃ | 1,1,1,2,3,4,5,5,5-nonafluoro-4- |
| | | (trifluoromethyl)-2-pentene |
| HFC-152-11mmtz | (CF₃)₂C═CHC₂F₅ | 1,1,1,4,4,5,5,5-octafluoro-2- |
| | | (trifluoromethyl)-2-pentene |
| HFC-152- | (CF₃)₂CFCF═CHCF₃ | 1,1,1,3,4,5,5,5-octafluoro-4- |
| 11mmyyz | | (trifluoromethyl)-2-pentene |
| PFBE | CF₃CF₂CF₂CF₂CH═CH₂ | 3,3,4,4,5,5,6,6,6-nonafluoro-1- |
| (or HFC-1549fz) | | hexene (or perfluorobutylethylene) |
| HFC-1549fztmm | CH₂═CHC(CF₃)₃ | 4,4,4-trifluoro-3,3- |
| | | bis(trifluoromethyl)-1-butene |
| HFC-1549mmtts | (CF₃)₂C═C(CH₃)(CF₃) | 1,1,1,4,4,4-hexafluoro-3-methyl-2- |
| | | (trifluoromethyl)-2-butene |
| HFC-1549fycz | CH₂═CFCF₂CH(CF₃)₂ | 2,3,3,5,5,5-hexafluoro-4- |
| | | (trifluoromethyl)-1-pentene |
| HFC-1549myts | CF₃CF═C(CH₃)CF₂CF₃ | 1,1,1,2,4,4,5,5,5-nonafluoro-3- |
| | | methyl-2-pentene |
| HFC-1549mzzz | CF₃CH═CHCH(CF₃)₂ | 1,1,1,5,5,5-hexafluoro-4- |
| | | (trifluoromethyl)-2-pentene |
| HFC-1558szy | CF₃CF₂CF₂CF═CHCH₃ | 3,4,4,5,5,6,6,6-octafluoro-2-hexene |
| HFC-1558fzccc | CH₂═CHCF₂CF₂CF₂CHF₂ | 3,3,4,4,5,5,6,6-octafluoro-2-hexene |
| HFC-1558mmtzc | (CF₃)₂C═CHCF₂CH₃ | 1,1,1,4,4-pentafluoro-2- |
| | | (trifluoromethyl)-2-pentene |
| HFC-1558ftmf | CH₂═C(CF₃)CH₂C₂F₅ | 4,4,5,5,5-pentafluoro-2- |
| | | (trifluoromethyl)-1-pentene |
| HFC-1567fts | CF₃CF₂CF₂C(CH₃)═CH₂ | 3,3,4,4,5,5,5-heptafluoro-2-methyl- |
| | | 1-pentene |
| HFC-1567szz | CF₃CF₂CF₂CH═CHCH₃ | 4,4,5,5,6,6,6-heptafluoro-2-hexene |
| HFC-1567fzfc | CH₂═CHCH₂CF₂C₂F₅ | 4,4,5,5,6,6,6-heptafluoro-1-hexene |
| HFC-1567sfyy | CF₃CF₂CF═CFC₂H₅ | 1,1,1,2,2,3,4-heptafluoro-3-hexene |
| HFC-1567fzfy | CH₂═CHCH₂CF(CF₃)₂ | 4,5,5,5-tetrafluoro-4- |
| | | (trifluoromethyl)-1-pentene |
| HFC-1567myzzm | CF₃CF═CHCH(CF₃)(CH₃) | 1,1,1,2,5,5,5-heptafluoro-4-methyl- |
| | | 2-pentene |
| HFC-1567mmtyf | (CF₃)₂C═CFC₂H₅ | 1,1,1,3-tetrafluoro-2- |
| | | (trifluoromethyl)-2-pentene |
| FC-161-14myy | CF₃CF═CFCF₂CF₂C₂F₅ | 1,1,1,2,3,4,4,5,5,6,6,7,7,7- |
| | | tetradecafluoro-2-heptene |
| FC-161-14mcyy | CF₃CF₂CF═CFCF₂C₂F₅ | 1,1,1,2,2,3,4,5,5,6,6,7,7,7- |
| | | tetradecafluoro-2-heptene |
| HFC-162-13mzy | CF₃CH═CFCF₂CF₂C₂F₅ | 1,1,1,3,4,4,5,5,6,6,7,7,7- |
| | | tridecafluoro-2-heptene |
| HFC162-13myz | CF₃CF═CHCF₂CF₂C₂F₅ | 1,1,1,2,4,4,5,5,6,6,7,7,7- |
| | | tridecafluoro-2-heptene |
| HFC-162-13mczy | CF₃CF₂CH═CFCF₂C₂F₅ | 1,1,1,2,2,4,5,5,6,6,7,7,7- |
| | | tridecafluoro-3-heptene |
| HFC-162-13mcyz | CF₃CF₂CF═CHCF₂C₂F₅ | 1,1,1,2,2,3,5,5,6,6,7,7,7- |
| | | tridecafluoro-3-heptene |
| PEVE | CF₂═CFOCF₂CF₃ | pentafluoroethyl trifluorovinyl ether |
| PMVE | CF₂═CFOCF₃ | trifluoromethyl trifluorovinyl ether |

The compounds listed in Table 2 and Table 3 are available commercially or may be prepared by processes known in the art or as described herein.

1,1,1,4,4-pentafluoro-2-butene may be prepared from 1,1,1,2,4,4-hexafluorobutane (CHF₂CH₂CHFCF₃) by dehydrofluorination over solid KOH in the vapor phase at room temperature. The synthesis of 1,1,1,2,4,4-hexafluorobutane is described in U.S. Pat. No. 6,066,768. 1,1,1,4,4,4-hexafluoro-2-butene may be prepared from 1,1,1,4,4,4-hexafluoro-2-iodobutane (CF₃CHICH₂CF₃) by reaction with KOH using a phase transfer catalyst at about 60° C. The synthesis of 1,1,1,4,4,4-hexafluoro-2-iodobutane may be carried out by reaction of perfluoromethyl iodide (CF₃I) and 3,3,3-trifluoropropene (CF₃CH═CH₂) at about 200° C. under autogenous pressure for about 8 hours.

3,4,4,5,5,5-hexafluoro-2-pentene may be prepared by dehydrofluorination of 1,1,1,2,2,3,3-heptafluoropentane (CF₃CF₂CF₂CH₂CH₃) using solid KOH or over a carbon catalyst at 200-300° C. 1,1,1,2,2,3,3-heptafluoropentane may be prepared by hydrogenation of 3,3,4,4,5,5,5-heptafluoro-1-pentene (CF₃CF₂CF₂CH═CH₂).

1,1,1,2,3,4-hexafluoro-2-butene may be prepared by dehydrofluorination of 1,1,1,2,3,3,4-heptafluorobutane (CH₂FCF₂CHFCF₃) using solid KOH.

1,1,1,2,4,4-hexafluoro-2-butene may be prepared by dehydrofluorination of 1,1,1,2,2,4,4-heptafluorobutane (CHF₂CH₂CF₂CF₃) using solid KOH.

1,1,1,3,4,4-hexafluoro2-butene may be prepared by dehydrofluorination of 1,1,1,3,3,4,4-heptafluorobutane (CF₃CH₂CF₂CHF₂) using solid KOH.

1,1,1,2,4-pentafluoro-2-butene may be prepared by dehydrofluorination of 1,1,1,2,2,3-hexafluorobutane (CH₂FCH₂CF₂CF₃) using solid KOH.

1,1,1,3,4-pentafluoro-2-butene may be prepared by dehydrofluorination of 1,1,1,3,3,4-hexafluorobutane (CF₃CH₂CF₂CH₂F) using solid KOH.

1,1,1,3-tetrafluoro-2-butene may be prepared by reacting 1,1,1,3,3-pentafluorobutane (CF₃CH₂CF₂CH₃) with aqueous KOH at 120° C.

1,1,1,4,4,5,5,5-octafluoro-2-pentene may be prepared from (CF₃CHICH₂CF₂CF₃) by reaction with KOH using a phase transfer catalyst at about 60° C. The synthesis of 4-iodo-1,1,1,2,2,5,5,5-octafluoropentane may be carried out by reaction of perfluoroethyliodide (CF₃CF₂I) and 3,3,3-trifluoropropene at about 200° C. under autogenous pressure for about 8 hours.

1,1,1,2,2,5,5,6,6,6-decafluoro-3-hexene may be prepared from 1,1,1,2,2,5,5,6,6,6-decafluoro-3-iodohexane (CF₃CF₂CHICH₂CF₂CF₃) by reaction with KOH using a phase transfer catalyst at about 60° C. The synthesis of 1,1,1,2,2,5,5,6,6,6-decafluoro-3-iodohexane may be carried out by reaction of perfluoroethyliodide (CF₃CF₂I) and 3,3,4,4,4-pentafluoro-1-butene (CF₃CF₂CH═CH₂) at about 200° C. under autogenous pressure for about 8 hours.

1,1,1,4,5,5,5-heptafluoro-4-(trifluoromethyl)-2-pentene may be prepared by the dehydrofluorination of 1,1,1,2,5,5,5-heptafluoro-4-iodo-2-(trifluoromethyl)-pentane (CF₃CHICH₂CF(CF₃)₂) with KOH in isopropanol. CF₃CHICH₂CF(CF₃)₂ is made from reaction of (CF₃)₂CFI with CF₃CH═CH₂ at high temperature, such as about 200° C.

1,1,1,4,4,5,5,6,6,6-decafluoro-2-hexene may be prepared by the reaction of 1,1,1,4,4,4-hexafluoro-2-butene (CF₃CH═CHCF₃) with tetrafluoroethylene (CF₂═CF₂) and antimony pentafluoride (SbF₅).

2,3,3,4,4-pentafluoro-1-butene may be prepared by dehydrofluorination of 1,1,2,2,3,3-hexafluorobutane over fluorided alumina at elevated temperature.

2,3,3,4,4,5,5,5-ocatafluoro-1-pentene may be prepared by dehydrofluorination of 2,2,3,3,4,4,5,5,5-nonafluoropentane over solid KOH.

1,2,3,3,4,4,5,5-octafluoro-1-pentene may be prepared by dehydrofluorination of 2,2,3,3,4,4,5,5,5-nonafluoropentane over fluorided alumina at elevated temperature.

Many of the compounds of Formula I, Formula II, Table 1, Table 2 and Table 3 exist as different configurational isomers or stereoisomers. When the specific isomer is not designated, the present invention is intended to include all single configurational isomers, single stereoisomers, or any combination thereof. For instance, F11E is meant to represent the E-isomer, Z-isomer, or any combination or mixture of both isomers in any ratio. As another example, HFC-1225ye is meant to represent the E-isomer, Z-isomer, or any combination or mixture of both isomers in any ratio.

In one embodiment, the present compositions may further comprise at least one hydrofluorocarbon (HFC). HFC compounds of the present invention comprise saturated compounds containing carbon, hydrogen, and fluorine. Of particular utility are hydrofluorocarbons having 1-7 carbon atoms and having a normal boiling point of from about −90° C. to about 80° C. Hydrofluorocarbons are commercial products available from a number of sources such as E. I. du Pont de Nemours and Company, Fluoroproducts, Wilmington, Del., 19898, USA, or may be prepared by methods known in the art. Representative hydrofluorocarbon compounds include but are not limited to fluoromethane (CH₃F, HFC-41), difluoromethane (CH₂F₂, HFC-32), trifluoromethane (CHF₃, HFC-23), pentafluoroethane (CF₃CHF₂, HFC-125), 1,1,2,2-tetrafluoroethane (CHF₂CHF₂, HFC-134), 1,1,1,2-tetrafluoroethane (CF₃CH₂F, HFC-134a), 1,1,1-trifluoroethane (CF₃CH₃, HFC-143a), 1,1-difluoroethane (CHF₂CH₃, HFC-152a), fluoroethane (CH₃CH₂F, HFC-161), 1,1,1,2,2,3,3-heptafluoropropane (CF₃CF₂CHF₂, HFC-227ca), 1,1,1,2,3,3,3-heptafluoropropane (CF₃CHFCF₃, HFC-227ea), 1,1,2,2,3,3,-hexafluoropropane (CHF₂CF₂CHF₂, HFC-236ca), 1,1,1,2,2,3-hexafluoropropane (CF₃CF₃CH₂F, HFC-236cb), 1,1,1,2,3,3-hexafluoropropane (CF₃CHFCHF₂, HFC-236ea), 1,1,1,3,3,3-hexafluoropropane (CF₃CH₂CF₃, HFC-236fa), 1,1,2,2,3-pentafluoropropane (CHF₂CF₂CH₂F, HFC-245ca), 1,1,1,2,2-pentafluoropropane (CF₃CF₂CH₃, HFC-245cb), 1,1,2,3,3-pentafluoropropane (CHF₂CHFCHF₂, HFC-245ea), 1,1,1,2,3-pentafluoropropane (CF₃CHFCH₂F, HFC-245eb), 1,1,1,3,3-pentafluoropropane (CF₃CH₂CHF₂, HFC-245fa), 1,2,2,3-tetrafluoropropane (CH₂FCF₂CH₂F, HFC-254ca), 1,1,2,2-tetrafluoropropane (CHF₂CF₂CH₃, HFC-254cb), 1,1,2,3-tetrafluoropropane (CHF₂CHFCH₂F, HFC-254ea), 1,1,1,2-tetrafluoropropane (CF₃CHFCH₃, HFC-254eb), 1,1,3,3-tetrafluoropropane (CHF₂CH₂CHF₂, HFC-254fa), 1,1,1,3-tetrafluoropropane (CF₃CH₂CH₂F, HFC-254fb), 1,1,1-trifluoropropane (CF₃CH₂CH₃, HFC-263fb), 2,2-difluoropropane (CH₃CF₂CH₃, HFC-272ca), 1,2-difluoropropane (CH₂FCHFCH₃, HFC-272ea), 1,3-difluoropropane (CH₂FCH₂CH₂F, HFC-272fa), 1,1-difluoropropane (CHF₂CH₂CH₃, HFC-272fb), 2-fluoropropane (CH₃CHFCH₃, HFC-281ea), 1-fluoropropane (CH₂FCH₂CH₃, HFC-281fa), 1,1,2,2,3,3,4,4-octafluorobutane (CHF₂CF₂CF₂CHF₂, HFC-338 pcc), 1,1,1,2,2,4,4,4-octafluorobutane (CF₃CH₂CF₂CF₃, HFC-338mf), 1,1,1,3,3-pentafluorobutane (CF₃CH₂CHF₂, HFC-365mfc), 1,1,1,2,3,4,4,5,5,5-decafluoropentane (CF₃CHFCHFCF₂CF₃, HFC-43-10mee), and 1,1,1,2,2,3,4,5,5,6,6,7,7,7-tetradecafluoroheptane (CF₃CF₂CHFCHFCF₂CF₂CF₃, HFC-63-14mee).

In another embodiment, the present compositions may further comprise at least one hydrocarbon. The hydrocarbons of the present invention comprise compounds having only carbon and hydrogen. Of particular utility are compounds having from about 3 to about 7 carbon atoms. Hydrocarbons are commercially available through numerous chemical suppliers. Representative hydrocarbons include but are not limited to propane, n-butane, isobutane, cyclobutane, n-pentane, 2-methylbutane, 2,2-dimethylpropane, cyclopentane, n-hexane, 2-methylpentane, 2,2-dimethylbutane, 2,3-dimethylbutane, 3-methylpentane, cyclohexane, n-heptane, and cycloheptane.

In another embodiment, the present compositions may further comprise at least one additional compound which comprises hydrocarbons containing heteroatoms, such as dimethylether (DME, CH₃OCH₃. DME is commercially available.

In another embodiment, the present compositions may further comprise ammonia (NH₃), which is commercially available from various sources or may be prepared by methods known in the art.

In another embodiment, the present compositions may further comprise carbon dioxide (CO₂), which is commercially available from various sources or may be prepared by methods known in the art.

In one embodiment, the compositions of the present invention may further comprise at least one lubricant selected from the group consisting of mineral oils, alkylbenzenes, poly-alpha-olefins, silicone oils, polyoxyalkylene glycol ethers, polyol esters, polyvinylethers, and mixtures thereof. Lubricants of the present invention comprise those suitable for use with refrigeration or air-conditioning apparatus. Among these lubricants are those conventionally used in compression refrigeration apparatus utilizing chlorofluorocarbon refrigerants. Such lubricants and their properties are discussed in the 1990 ASHRAE Handbook, Refrigeration Systems and Applications, chapter 8, titled “Lubricants in Refrigeration Systems”, pages 8.1 through 8.21, herein incorporated by reference. Lubricants of the present invention may comprise those commonly known as “mineral oils” in the field of compression refrigeration lubrication. Mineral oils comprise paraffins (i.e. straight-chain and branched-carbon-chain, saturated hydrocarbons), naphthenes (i.e. cyclic or ring structure saturated hydrocarbons, which may be paraffins) and aromatics (i.e. unsaturated, cyclic hydrocarbons containing one or more rings characterized by alternating double bonds). Lubricants of the present invention further comprise those commonly known as “synthetic oils” in the field of compression refrigeration lubrication. Synthetic oils comprise alkylaryls (i.e. linear and branched alkyl alkylbenzenes), synthetic paraffins and naphthenes, silicones, and poly-alpha-olefins. Representative conventional lubricants of the present invention are the commercially available BVM 100 N (paraffinic mineral oil sold by BVA Oils), napthenic mineral oil commercially available under the trademark from Suniso® 3GS and Suniso® 5GS by Crompton Co., naphthenic mineral oil commercially available from Pennzoil under the trademark Sontex® 372LT, naphthenic mineral oil commercially available from Calument Lubricants under the trademark Calumet® RO-30, linear alkylbenzenes commercially available from Shrieve Chemicals under the trademarks Zerol® 75, Zerol® 150 and Zerol® 500 and branched alkylbenzene, sold by Nippon Oil as HAB 22.

In another embodiment, lubricants of the present invention further comprise those which have been designed for use with hydrofluorocarbon refrigerants and are miscible with refrigerants of the present invention under compression refrigeration and air-conditioning apparatus' operating conditions. Such lubricants and their properties are discussed in “Synthetic Lubricants and High-Performance Fluids”, R. L. Shubkin, editor, Marcel Dekker, 1993. Such lubricants include, but are not limited to, polyol esters (POEs) such as Castrol® 100 (Castrol, United Kingdom), polyalkylene glycols (PAGs) such as RL-488A from Dow (Dow Chemical, Midland, Mich.), and polyvinyl ethers (PVEs).

Lubricants of the present invention are selected by considering a given compressor's requirements and the environment to which the lubricant will be exposed.

The compositions of the present invention may be prepared by any convenient method to combine the desired amount of the individual components. A preferred method is to weigh the desired component amounts and thereafter combine the components in an appropriate vessel. Agitation may be used, if desired.

The present invention further relates to a method for stabilizing a composition comprising CF₃I, said method comprising adding an effective amount of a stabilizer comprising at least one ionic liquid.

The present invention further relates to a process for producing cooling comprising condensing a composition comprising at least one ionic liquid and CF₃I; and thereafter evaporating said composition in the vicinity of a body to be cooled.

A body to be cooled may be any space, location or object requiring refrigeration or air-conditioning. In stationary applications the body may be the interior of a structure, i.e. residential or commercial, or a storage location for perishables, such as food or pharmaceuticals. For mobile refrigeration applications the body may be incorporated into a transportation unit for the road, rail, sea or air. Certain refrigeration systems operate independently with regards to any moving carrier, these are known as “intermodal” systems. Such intermodal systems include “containers” (combined sea/land transport) as well as “swap bodies” (combined road and rail transport).

The present invention further relates to a process for producing heat comprising condensing a composition comprising at least one ionic liquid and CF₃I in the vicinity of a body to be heated, and thereafter evaporating said composition.

A body to be heated may be any space, location or object requiring heat. These may be the interior of structures either residential or commercial in a similar manner to the body to be cooled. Additionally, mobile units as described for cooling may be similar to those requiring heating. Certain transport units require heating to prevent the material being transported from solidifying inside the transport container.

It is not uncommon for air to leak into a refrigeration, air-conditioning system or heat pump. The reaction with the oxygen in air may lead to oxidation of certain components of the system including the working fluid. Thus, in another embodiment, also disclosed is a method for reducing degradation of a composition comprising CF₃I, wherein said degradation is caused by the presence of inadvertent air; for example in a refrigeration, air-conditioning or heat pump system, said method comprising adding an effective amount of stabilizer comprising at least one ionic liquid to the composition comprising CF₃I.

In another embodiment, also disclosed is a method for reducing reaction with oxygen for a composition comprising CF₃I; said method comprising adding an effective amount of stabilizer comprising at least one ionic liquid to the composition comprising CF₃I.

### EXAMPLES

For the examples the following descriptions apply: Ucon® PAG 488 is a trademark for a polyalkylene glycol lubricant commercially available from The Dow Chemical Company. EmimBF₄ is 1-ethyl-3-methylimidazolium tetrafluoroborate available from Fluka (Sigma-Aldrich) or BASF (Mount Olive, N.J.).

### Example 1

### Free Fluoride Determination for Stabilizer Before and after Thermal Exposure

Example 1 demonstrates that a dry ionic fluid is effective in reacting with free acids formed during thermal exposure of a fluoroolefin. at 175° C. EmimBF₄ was obtained from BASF (Mount Olive, N.J.) and several samples were tested for free fluoride ions by ion chromatography both prior to and after thermal exposure. The sample preparation is described in ASHRAE/ANSI (American Society of Heating, Refrigerating and Air-Conditioning Engineers and American National Standards Institute) Standard 97-2004.

The samples were prepared and analyzed as follows:
1. Metal coupons of copper, aluminum and steel were placed in thick walled glass tubes.
2. Working fluid samples, including refrigerant (HFC-134a) and stabilizer (EmimBF₄) in a 50:50 weight ratio were added to the glass tubes as described in the standard.
3. The tubes were sealed with a glass blowing torch.
4. The sealed tubes were heated in an oven for 15 days at 175° C.
5. After 15 days, the sealed tubes were removed from the oven and examined and analyzed.
6. For the ion chromatography analysis, the contents of each tube was transferred to a beaker and the tube was washed with two 5 mL washes of petroleum ether followed by one 5 mL wash of 3% aqueous HNO₃ solution followed by two 5 mL deionized water washes (all washings being added to the beaker). Metal coupons were removed from the sample.
7. A Dionex ion chromatograph with oven, autosampler, eluent generator, conductivity detector and gradient pump, models LC25/AS40/EG 40/CD20/GP20 respectively and with an Ionpac® AG15 column (4×150 mm) was used to measure free fluoride ion in all the samples.

Table 4 lists the concentration of free fluoride ion for 3 samples in parts per billion (ppb). The samples were 1) a fresh sample not treated by thermal exposure directly from container; 2) a “wet” sample, not dried prior to thermal exposure; and 3) a dry sample, dried over 3 mm molecular sieves prior to thermal exposure. Water content was determined by titration using a Mettler Toledo DL39 Karl Fisher coulometric titrator.

TABLE 4

| | | Fluoride ion |
|---|---|---|
| Sample | Water concentration | concentration, ppb |
| Fresh EmimBF₄ | 217 ppm | 10162 |
| Wet EmimBF₄, after 15 days | 217 ppm | 6055 |
| at 175° C. | | |
| Dry EmimBF₄, after 15 days | 6.7 ppm | 3795 |
| at 175° C. | | |

The data shows that after heat exposure the EmimBF₄ stabilizer composition has lower free fluoride indicating it is acting as an acid scavenger. EmimBF₄ added as a component in the blend abstracts acid and hence the free fluoride measured in the thermally exposed samples is lower than the starting ionic fluid.

### Example 2

### Refrigeration System Chemical Stability

A chemical stability test is run under conditions described in ASHRAE/ANSI (American Society of Heating, Refrigerating and Air-Conditioning Engineers and American National Standards Institute) Standard 97-2004 to determine chemical stability of the stabilized compositions of the present invention as compared to compositions with no stabilizers.

The procedure is given here:
1. Metal coupons of copper, aluminum and steel are placed in thick walled glass tubes.
2. Working fluid samples, including lubricant, are prepared with and without stabilizers, and optionally with 2 volume % air added to the tube.
3. Samples are added to the sealed tubes as described in the standard.
4. The tubes are sealed with a glass blowing torch.
5. The sealed tubes are heated in an oven for 14 days at the specified temperature.
6. After 14 days, the sealed tubes are removed from the oven and examined for metal/liquid appearance, proper volume of liquid, appearance of glass, and absence of extraneous materials such as metal fines.
7. Ratings are assigned to each sample based upon the following criteria (per industry practice):
   1=light changes on coupons and liquids;
   2=light to moderate changes on coupons or liquids;
   3=moderate to significant changes on coupons or liquids;
   4=severe changes on coupons or liquids;
   5=extreme changes on coupons or liquids, i.e. black liquid or coked with many deposits.
      Table 5 lists estimated results for stabilizers of the present invention as compared to unstabilized compositions. The lubricant, Ucon® PAG 488, is combined with the working fluid (refrigerant) as set forth in Table 5 below to produce a composition that was 50 wt % working fluid and 50 wt % lubricant.

TABLE 5

| | | | Stabilizer | | | |
|---|---|---|---|---|---|---|
| | | | weight percent | | | |
| | | | in Refrigerant/ | | | |
| | | | lubricant | With | Temp, | Results - |
| Refrigerant | Lubricant | Stabilizer | mixture: | 2 vol % Air | (° C.) | Rating |
| CF₃I | PAG 488 | none | 0 | yes | 130 | 5 |
| CF₃I | PAG 488 | none | 0 | no | 130 | 4 |
| CF₃I | PAG 488 | EmimBF₄ | 2 | yes | 130 | 3 |
| CF₃I | PAG 488 | EmimBF₄ | 2 | no | 130 | 2 |

Estimates indicate improved chemical stability in the presence of stabilizers with and without air present.

### Example 3

### Refrigeration System Chemical Stability

A chemical stability test is run under conditions described in ASHRAE/ANSI (American Society of Heating, Refrigerating and Air-Conditioning Engineers and American National Standards Institute) Standard 97-2004, as described for EXAMPLE 2, to determine chemical stability of the stabilized compositions of the present invention as compared to compositions with no stabilizers.

Table 6 lists estimates of visual appearance for each sample as described in the table. The lubricant was combined with the refrigerant to produce a composition that was 50 wt % refrigerant and 50 wt % lubricant. All samples were free of air and were exposed to 130° C. for 2 weeks.

TABLE 6

| | | | Stabilizer | |
|---|---|---|---|---|
| | | | weight | |
| | | | percent in | |
| | | | Refrigerant/ | |
| | | | lubricant | |
| Refrigerant | Lubricant | Stabilizer | mixture: | Visual rating |
| CF₃I | PAG 488 | none | 0 | 5 |
| CF₃I | PAG 488 | EmimBF₄ | 2 | 3 |
| CF₃I | PAG 488 | Tocopherol | 2 | 3 |
| CF₃I | PAG 488 | Tocopherol + | 2 | 2 |
| | | EmimBF₄ | | |
| | | (1:1 wt ratio) | | |

The above estimates indicate improved chemical stability of CF₃I containing compositions in the presence of stabilizers as disclosed herein with and without air present. A greater improvement is indicated for the combination of tocopherol/EmimBF₄ wherein the total concentration is the same as the tocopherol or EmimBF₄ when either of these stabilizers is used alone.

What is claimed is:

1. A composition comprising at least one ionic liquid and CF₃I.

2. The composition of claim 1 wherein said ionic liquid comprises at least one cation selected from the group consisting of: 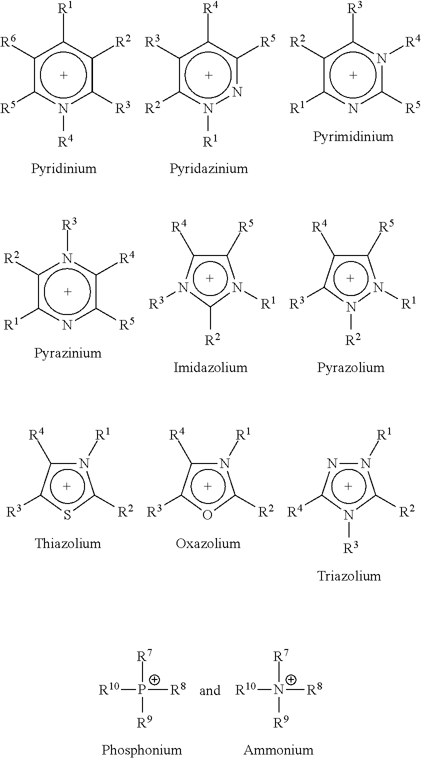
wherein R¹, R², R³, R⁴, R⁵ and R⁶ are each independently selected from the group consisting of:
(i) H;
(ii) halogen;
(iii) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH;
(iv) —CH₃, —C₂H₅, or C₃ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(v) C₆ to O₂₀ unsubstituted aryl, or O₃ to O₂₅ unsubstituted heteroaryl having one to three heteroatoms independently selected from the group consisting of O, N, Si and S; and
(vi) C₆ to O₂₅ substituted aryl, or C₃ to O₂₅ substituted heteroaryl having one to three heteroatoms independently selected from the group consisting of O, N, Si and S; wherein said substituted aryl or substituted heteroaryl has one to three substituents independently selected from the group consisting of:
1. —CH₃, —C₂H₅, or C₃ to O₂₅ straight-chain, branched or cyclic alkane or alkene, optionally substituted with at least one member selected from the group consisting of Cl, Br, F I, OH, NH₂ and SH,
2. OH,
3. NH₂, and
4. SH; and
wherein R⁷, R⁸, R⁹, and R¹⁰ are each independently selected from the group consisting of:
(vii) —CH₃, —C₂H₅, or C₃ to O₂₅ straight-chain, branched or cyclic alkane or alkene, optionally substituted with at least one member selected from the group consisting of Cl, Br, F, I, OH, NH₂ and SH;
(viii) —CH₃, —C₂H₅, or C₃ to O₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(ix) C₆ to O₂₅ unsubstituted aryl, or O₃ to O₂₅ unsubstituted heteroaryl having one to three heteroatoms independently selected from the group consisting of O, N, Si and S; and
(x) C₆ to O₂₅ substituted aryl, or C₃ to O₂₅ substituted heteroaryl having one to three heteroatoms independently selected from the group consisting of O, N, Si and S; wherein said substituted aryl or substituted heteroaryl has one to three substituents independently selected from the group consisting of:
(1) —CH₃, —O₂H₅, or C₃ to O₂₅ straight-chain, branched or cyclic alkane or alkene, optionally substituted with at least one member selected from the group consisting of Cl, Br, F, I, OH, NH₂ and SH,
(2) OH,
(3) NH₂, and
(4) SH; and
wherein optionally at least two of R¹, R², R³, R⁴, R⁵, R⁶, R⁷, R⁸, R⁹, and R¹⁰ can together form a cyclic or bicyclic alkanyl or alkenyl group.

3. The composition of claim 2 wherein any one of, or any group of more than one of, R¹, R², R³, R⁴, R⁵, R⁶, R⁷, R⁸, R⁹ and R¹⁰ comprises F—.

4. The composition of claim 1 wherein an ionic liquid comprises an anion selected from the group consisting of [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]²⁻, [PO₄]³⁻, [HPO₄]²⁻, [H₂PO₄]⁻, [HSO₃]⁻, [CuCl₂]⁻, Cl⁻, Br⁻, I⁻, SCN⁻ and any fluorinated anion.

5. The composition of claim 3 wherein the fluorinated anion is selected from the group consisting of [BF₄]⁻, [PF₆]⁻, [SbF₆]⁻, [CF₃SO₃]⁻, [HCF₂CF₂SO₃]⁻, [CF₃HFCCF₂SO₃]⁻, [HCClFCF₂SO₃]⁻, [(CF₃SO₂)₂N]⁻, [(CF₃CF₂SO₂)₂N]⁻, [(CF₃SO₂)₃C]⁻, [CF₃CO₂]⁻, [CF₃OCFHCF₂SO₃]⁻, [CF₃CF₂OCFHCF₂SO₃]⁻, [CF₃CFHOCF₂CF₂SO₃]⁻, [CF₂HCF₂OCF₂CF₂SO₃]⁻, [CF₂ICF₂OCF₂CF₂SO₃]⁻, [CF₃CF₂OCF₂CF₂SO₃]⁻, [(CF₂HCF₂SO₂)₂N]⁻, [(CF₃CFHCF₂SO₂)₂N]⁻, and F⁻.

6. The composition of claim 1 further comprising at least one additional compound selected from the group consisting of fluoroolefins, hydrofluorocarbons, hydrocarbons, dimethyl ether, carbon dioxide, ammonia, and mixtures thereof.

7. The composition of claim 1 further comprising a lubricant selected from the groups consisting of mineral oils, alkylbenzenes, poly-alpha-olefins, silicone oils, polyoxyalkylene glycol ethers, polyol esters, polyvinylethers, and mixtures thereof.

8. The composition of claim 1 further comprising at least one additional stabilizer selected from the group consisting of phenols, thiophosphates, butylated triphenylphosphorothionates, organo phosphates, phosphites, aryl alkyl ethers, terpenes, terpenoids, fullerenes, polyoxyalkylated aromatics, alkylated aromatics, epoxides, fluorinated epoxides, oxetanes, lactones, amines, alkylsilanes, benzophenone derivatives, thiols, thioethers, aryl sulfides, divinyl terephalate, diphenyl terephalate, ascorbic acid, nitromethane, and mixtures thereof.

9. The composition of claim 8 wherein:
a. the phenols comprise at least one compound selected from the group consisting of 2,6-di-tert-butyl-4-methylphenol; 2,6-di-tert-butyl-4-ethylphenol; 2,4-dimethyl-6-tertbutylphenol; tocopherol; hydroquinone; t-butyl hydroquinone; 4,4′-thio-bis(2-methyl-6-tert-butylphenol); 4,4′-thiobis(3-methyl-6-tertbutylphenol); 2,2′-thiobis(4-methyl-6-tert-butylphenol); 4,4′-methylenebis(2,6-di-tert-butylphenol); 4,4′-bis(2,6-di-tert-butylphenol); 2,2′-methylenebis(4-ethyl-6-tertbutylphenol); 2,2′-methylenebis(4-methyl-6-tert-butylphenol); 4,4-butylidenebis(3-methyl-6-tert-butylphenol); 4,4-isopropylidenebis(2,6-di-tert-butylphenol); 2,2′-methyleenbis(4-methyl-6-nonylphenol); 2,2′-isobutylidenebis(4,6-dimethylphenol; 2,2′-methylenebis(4-methyl-6-cyclohexylphenol, 2,2′-methylenebis(4-ethyl-6-tert-butylphenol); butylated hydroxyl toluene (BHT); 2,6-di-tert-alpha-dimethylamino-p-cresol; 4,4-thiobis(6-tert-butyl-m-cresol; acylaminophenols; 2,6-di-tert-butyl-4(N,N′-dimethylaminomethylphenol); bis(3-methyl-4-hydroxy-5-tert-butylbenzyl)sulfide; bis(3,5-di-tert-butyl-4-hydroxybenzyl)sulfide and mixtures thereof;
b. the thiophosphates comprise at least one compound selected from the group consisting of monothiophosphates, dithiophosphates, trithiophosphates, dialkylthiophosphate esters, and mixtures thereof;
c. the butylated triphenylphosphorothionates comprise at least one compound represented by Formula A: 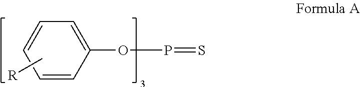
wherein each R is independently selected from H or tert-butyl;
d. the organophosphates comprise at least one compound selected from the group consisting of amine phosphates, trialkyl phosphates, triaryl phosphates, mixed alkyl-aryl phosphates, cyclic phosphates, and mixtures thereof;
e. the phosphites comprise at least one compound selected from the group consisting of tris-(di-tert-butylphenyl)phosphite, di-n-octyl phosphite, iso-decyl diphenyl phosphite, and mixtures thereof;
f. the aryl alkyl ethers comprise at least one compound represented by Formula B: 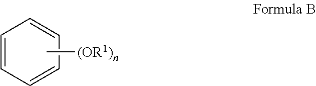
wherein n is 1, 2 or 3 and R¹ is an alkyl group of 1 to 16 carbon atoms;
g. the terpenes comprise at least one compound selected from the group consisting of isoprene, myrcene, allo-cimene, beta-ocimene, terebene, limonene, retinal, pinene, menthol, geraniol, farnesol, phytol, Vitamin A, terpinene, delta-3-carene, terpinolene, phellandrene, fenchene, dipentene, and mixtures thereof, and
h. the terpenoids comprise at least one compound selected from the group consisting of lycopene, betacarotene, zeaxanthin, hepaxanthin, and isotretinoin, abietane, ambrosane, aristolane, atisane, beyerane, bisabolane, bornane, caryophyllane, cedrane, dammarane, drimane, eremophilane, eudesmane, fenchane, gammacerane, germacrane, gibbane, grayanotoxane, guaiane, himachalane, hopane, humulane, kaurane, labdane, lanostane, lupane, p-menthane, oleanane, ophiobolane, picrasane, pimarane, pinane, podocarpane, protostane, rosane, taxane, thujane, trichothecane, ursane, and mixtures thereof;
i. the fullerenes comprise at least one compound selected from the group consisting of Buckminsterfullerene, [5,6]fullerene-C₇₀, fullerene-C₇₆, fullerene-C₇₈, fullerene-C₈₄, and mixtures thereof;
j. the polyoxyalkylated aromatics comprise at least one compound represented by Formula A, wherein the R¹ group is a polyoxyalkylated group comprising at least one —CH₂CH₂O— moiety;
k. the alkylated aromatics comprise at least one linear or branched alkylbenzene lubricants;
l. the epoxide stabilizers comprise at least one compound selected from the group consisting of 1,2-propylene oxide, 1,2-butylene oxide, butylphenylglycidy ether, pentylphenylglycidyl ether, hexylphenylglycidyl ether, heptylphenylglycidyl ether, octylphenylglycidyl ether, nonylphenylglycidyl ether, decylphenylglycidyl ether, glycidyl methylphenylether, 1,4-glycidyl phenyl diether, 4-methoxyphenylglycidyl ether, naphthyl glycidyl ether, 1,4-diglycidyl naphthyl diether, butylphenyl glycidyl ether, n-butyl glycidyl ether, isobutyl glycidyl ether, hexanediol diglycidyl ether, allyl glycidyl ether, polypropylene glycol diglycidyl ether, and mixtures thereof;
m. the fluorinated epoxides comprise at least one compound represented by Formula C: 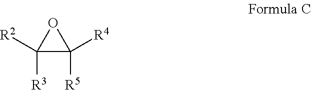
wherein each of R² through R⁵ is H, alkyl of 1-6 carbon atoms or fluoroalkyl of 1-6 carbon atoms with the proviso that at least one of R² through R⁵ is a fluoroalkyl group;
n. the oxetanes comprise at least one compound represented by Formula D: 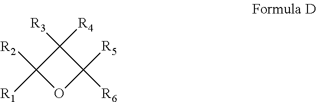
wherein R₁-R₆ are independently selected from hydrogen, alkyl or substituted alkyl, aryl or substituted aryl;
o. the lactones comprise at least one compound selected from the group consisting of gamma-butyrolactone, delta-gluconolactone, gamma-undecalactone; 6,7-dihydro-4(5H)-benzofuranone; 5,7-bis(1,1-dimethylethyl)-3-[2,3(or 3,4)-dimethylphenyl]-2(3H)-benzofuranone, and mixtures thereof;
p. the amines comprise at least one compound selected from the group consisting of triethylamine; tributylamine; diisopropylamine; triisopropylamine; triisobutylamine; p-phenylenediamine; diphenylamine; N-(1-methylethyl)-2-propylamine; 2,2,6,6-tetramethyl-4-piperidone; 2,2,6,6-tetramethyl-4-piperidinol; bis-(1,2,2,6,6-pentamethylpiperidyl); di-(2,2,6,6-tetramethyl-4-piperidyl)sebacate; poly-(N-hydroxyethyl-2,2,6,6-tetramethyl-4-hydroxy-piperidyl succinate; N-phenyl-N′-(1,3-dimethylbutyl)-p-phenylenediamine; N,N′-di-sec-butyl-p-phenylenediamine; tallow amines; N-methylbis(hydrogenated tallow alkyl)amine; phenol-alpha-naphthylamine, and mixtures thereof;
q. the alkyl silanes comprise at least one compound selected from the group consisting of bis(dimethylamino)methylsilane, tris(trimethylsilyl)silane, vinyltriethyoxysilane, vinyltrimethoxysilane, and mixtures thereof;
r. the benzophenone derivatives comprise at least one compound selected from the group consisting of 2,5-difluorobenzophenone; 2′,5′-dihydroxyacetophenone; 2-aminobenzophenone; 2-chlorobenzophenone; 2-fluorobenzophenone; 2-hydroxybenzophenone; 2-methylbenzophenone; 2-amino-4′-chlorobenzophenone; 2-amino-4′-fluorobenzophenone; 2-amino-5-bromo-2′-chlorobenzophenone; 2-amino-5-chlorobenzophenone; 2-amino-5-chloro-2′-fluorobenzophenone; 2-amino-5-nitrobenzophenone; 2-amino-5-nitro-2′-chlorobenzophenone; 2-amino-2′,5-dichlorobenzophenone; 2-chloro-4′-fluorobenzophenone; 2-hydroxy-4-methoxybenzophenone; 2-hydroxy-5-chlorobenzophenone; 2-methylamino-5-chlorobenzophenone; 3-methylbenzophenone; 3-nitrobenzophenone; 3-nitro-4′-chloro-4-fluorobenzophenone; 4-chlorobenzophenone; 4-fluorobenzophenone; 4-hydroxybenzophenone; 4-methoxybenzophenone; 4-methylbenzophenone; 4-nitrobenzophenone; 4-phenylbenzophenone; 4-chloro-3-nitrobenzophenone; 4-hydroxy-4′-chlorobenzophenone; 2,4-dihydroxybenzophenone; 2,4-dimethylbenzophenone; 2,5-dimethylbenzophenone; 3,4-diaminobenzophenone; 3,4-dichlorobenzophenone; 3,4-difluorobenzophenone; 3,4-dihydroxybenzophenone; 3,4-dimethylbenzophenone; 4,4′-bis(diethylamine)benzophenone; 4,4′-bis(dimethylamine)benzophenone; 4,4′-dichlorobenzophenone; 4,4′-difluorobenzophenone; 4,4′-dihydroxybenzophenone; 4,4′-dimethoxybenzophenone, and mixtures thereof;
s. the thiols comprise at least one compounds selected from the group consisting of: methanethiol, ethanethiol, Coenzyme A, dimercaptosuccinic acid, grapefruit mercaptan, cysteine, and lipoamide, and mixtures thereof;
t. the thioethers comprise at least one compound selected from the group consisting of: benzyl phenyl sulfide, diphenyl sulfide, dioctadecyl 3,3′-thiodipropionate, didodecyl 3,3′-thiopropionate, and mixtures thereof; and
u. the aryl sulfides comprise at least one compound selected from the group consisting of benzyl phenyl sulfide, diphenyl sulfide, and dibenzyl sulfide, and mixtures thereof.

10. The composition of claim 6 wherein said fluoroolefin is at least one compound selected from the group consisting of:
(i) fluoroolefins of the formula E- or Z—R¹CH═CHR², wherein R¹ and R² are, independently, C₁ to O₆ perfluoroalkyl groups;
(ii) cyclic fluoroolefins of the formula cyclo-[CX═CY(CZW)ₙ—], wherein X, Y, Z, and W, independently, are H or F, and n is an integer from 2 to 5; and
(iii) fluoroolefins selected from the group consisting of: tetrafluoroethylene (CF₂═CF₂); hexafluoropropene (CF₃CF═CF₂); 1,2,3,3,3-pentafluoro-1-propene (CHF═CFCF₃), 1,1,3,3,3-pentafluoro-1-propene (CF₂═CHCF₃), 1,1,2,3,3-pentafluoro-1-propene (CF₂═CFCHF₂), 1,2,3,3-tetrafluoro-1-propene (CHF═CFCHF₂), 2,3,3,3-tetrafluoro-1-propene (CH₂═CFCF₃), 1,3,3,3-tetrafluoro-1-propeneCHF═CHCF₃), 1,1,2,3-tetrafluoro-1-propene (CF₂═CFCH₂F), 1,1,3,3-tetrafluoro-1-propene (CF₂═CHCHF₂), 1,2,3,3-tetrafluoro-1-propene (CHF═CFCHF₂), 3,3,3-trifluoro-1-propene (CH₂═CHCF₃), 2,3,3-trifluoro-1-propene (CHF₂CF═CH₂); 1,1,2-trifluoro-1-propene (CH₃CF═CF₂); 1,2,3-trifluoro-1-propene (CH₂FCF═CF₂); 1,1,3-trifluoro-1-propene (CH₂FCH═CF₂); 1,3,3-trifluoro-1-propene (CHF₂CH═CHF); 1,1,1,2,3,4,4,4-octafluoro-2-butene (CF₃CF═CFCF₃); 1,1,2,3,3,4,4,4-octafluoro-1-butene (CF₃CF₂CF═CF₂); 1,1,1,2,4,4,4-heptafluoro-2-butene (CF₃CF═CHCF₃); 1,2,3,3,4,4,4-heptafluoro-1-butene (CHF═CFCF₂CF₃); 1,1,1,2,3,4,4-heptafluoro-2-butene (CHF₂CF═CFCF₃); 1,3,3,3-tetrafluoro-2-(trifluoromethyl)-1-propene ((CF₃)₂C═CHF); 1,1,3,3,4,4,4-heptafluoro-1-butene (CF₂═CHCF₂CF₃); 1,1,2,3,4,4,4-heptafluoro-1-butene (CF₂═CFCHFCF₃); 1,1,2,3,3,4,4-heptafluoro-1-butene (CF₂═CFCF₂CHF₂); 2,3,3,4,4,4-hexafluoro-1-butene (CF₃CF₂CF═CH₂); 1,3,3,4,4,4-hexafluoro-1-butene (CHF═CHCF₂CF₃); 1,2,3,4,4,4-hexafluoro-1-butene (CHF═CFCHFCF₃); 1,2,3,3,4,4-hexafluoro-1-butene (CHF═CFCF₂CHF₂); 1,1,2,3,4,4-hexafluoro-2-butene (CHF₂CF═CFCHF₂); 1,1,1,2,3,4-hexafluoro-2-butene (CH₂FCF═CFCF₃); 1,1,1,2,4,4-hexafluoro-2-butene (CHF₂CH═CFCF₃); 1,1,1,3,4,4-hexafluoro-2-butene (CF₃CH═CFCHF₂); 1,1,2,3,3,4-hexafluoro-1-butene (CF₂═CFCF₂CH₂F); 1,1,2,3,4,4-hexafluoro-1-butene (CF₂═CFCHFCHF₂); 3,3,3-trifluoro-2-(trifluoromethyl)-1-propene (CH₂═C(CF₃)₂); 1,1,1,2,4-pentafluoro-2-butene (CH₂FCH═CFCF₃); 1,1,1,3,4-pentafluoro-2-butene (CF₃CH═CFCH₂F); 3,3,4,4,4-pentafluoro-1-butene (CF₃CF₂CH═CH₂); 1,1,1,4,4-pentafluoro-2-butene (CHF₂CH═CHCF₃); 1,1,1,2,3-pentafluoro-2-butene (CH₃CF═CFCF₃); 2,3,3,4,4-pentafluoro-1-butene (CH₂═CFCF₂CHF₂); 1,1,2,4,4-pentafluoro-2-butene (CHF₂CF═CHCHF₂); 1,1,2,3,3-pentafluoro-1-butene (CH₃CF₂CF═CF₂); 1,1,2,3,4-pentafluoro-2-butene (CH₂FCF═CFCHF₂); 1,1,3,3,3-pentafluoro-2-methyl-1-propene (CF₂═C(CF₃)(CH₃)); 2-(difluoromethyl)-3,3,3-trifluoro-1-propene (CH₂═C(CHF₂)(CF₃)); 2,3,4,4,4-pentafluoro-1-butene (CH₂═CFCHFCF₃); 1,2,4,4,4-pentafluoro-1-butene (CHF═CFCH₂CF₃); 1,3,4,4,4-pentafluoro-1-butene (CHF═CHCHFCF₃); 1,3,3,4,4-pentafluoro-1-butene (CHF═CHCF₂CHF₂); 1,2,3,4,4-pentafluoro-1-butene (CHF═CFCHFCHF₂); 3,3,4,4-tetrafluoro-1-butene (CH₂═CHCF₂CHF₂); 1,1-difluoro-2-(difluoromethyl)-1-propene (CF₂═C(CHF₂)(CH₃)); 1,3,3,3-tetrafluoro-2-methyl-1-propene (CHF═C(CF₃)(CH₃)); 3,3-difluoro-2-(difluoromethyl)-1-propene (CH₂═C(CHF₂)₂); 1,1,1,2-tetrafluoro-2-butene (CF₃CF═CHCH₃); 1,1,1,3-tetrafluoro-2-butene (CH₃CF═CHCF₃); 1,1,1,2,3,4,4,5,5,5-decafluoro-2-pentene (CF₃CF═CFCF₂CF₃); 1,1,2,3,3,4,4,5,5,5-decafluoro-1-pentene (CF₂═CFCF₂CF₂CF₃); 1,1,1,4,4,4-hexafluoro-2-(trifluoromethyl)-2-butene ((CF₃)₂C═CHCF₃); 1,1,1,2,4,4,5,5,5-nonafluoro-2-pentene (CF₃CF═CHCF₂CF₃); 1,1,1,3,4,4,5,5,5-nonafluoro-2-pentene (CF₃CH═CFCF₂CF₃); 1,2,3,3,4,4,5,5,5-nonafluoro-1-pentene (CHF═CFCF₂CF₂CF₃); 1,1,3,3,4,4,5,5,5-nonafluoro-1-pentene (CF₂═CHCF₂CF₂CF₃); 1,1,2,3,3,4,4,5,5-nonafluoro-1-pentene (CF₂═CFCF₂CF₂CHF₂); 1,1,2,3,4,4,5,5,5-nonafluoro-2-pentene (CHF₂CF═CFCF₂CF₃); 1,1,1,2,3,4,4,5,5-nonafluoro-2-pentene (CF₃CF═CFCF₂CHF₂); 1,1,1,2,3,4,5,5,5-nonafluoro-2-pentene (CF₃CF═CFCHFCF₃); 1,2,3,4,4,4-hexafluoro-3-(trifluoromethyl)-1-butene (CHF═CFCF(CF₃)₂); 1,1,2,4,4,4-hexafluoro-3-(trifluoromethyl)-1-butene (CF₂═CFCH(CF₃)₂); 1,1,1,4,4,4-hexafluoro-2-(trifluoromethyl)-2-butene (CF₃CH═C(CF₃)₂); 1,1,3,4,4,4-hexafluoro-3-(trifluoromethyl)-1-butene (CF₂═CHCF(CF₃)₂); 2,3,3,4,4,5,5,5-octafluoro-1-pentene (CH₂═CFCF₂CF₂CF₃); 1,2,3,3,4,4,5,5-octafluoro-1-pentene (CHF═CFCF₂CF₂CHF₂); 3,3,4,4,4-pentafluoro-2-(trifluoromethyl)-1-butene (CH₂═C(CF₃)CF₂CF₃); 1,1,4,4,4-pentafluoro-3-(trifluoromethyl)-1-butene (CF₂═CHCH(CF₃)₂); 1,3,4,4,4-pentafluoro-3-(trifluoromethyl)-1-butene (CHF═CHCF(CF₃)₂); 1,1,4,4,4-pentafluoro-2-(trifluoromethyl)-1-butene (CF₂═C(CF₃)CH₂CF₃); 3,4,4,4-tetrafluoro-3-(trifluoromethyl)-1-butene ((CF₃)₂CFCH═CH₂); 3,3,4,4,5,5,5-heptafluoro-1-pentene (CF₃CF₂CF₂CH═CH₂); 2,3,3,4,4,5,5-heptafluoro-1-pentene (CH₂═CFCF₂CF₂CHF₂); 1,1,3,3,5,5,5-heptafluoro-1-butene (CF₂═CHCF₂CH₂CF₃); 1,1,1,2,4,4,4-heptafluoro-3-methyl-2-butene (CF₃CF═C(CF₃)(CH₃)); 2,4,4,4-tetrafluoro-3-(trifluoromethyl)-1-butene (CH₂═CFCH(CF₃)₂); 1,4,4,4-tetrafluoro-3-(trifluoromethyl)-1-butene (CHF═CHCH(CF₃)₂); 1,1,1,4-tetrafluoro-2-(trifluoromethyl)-2-butene (CH₂FCH═C(CF₃)₂); 1,1,1,3-tetrafluoro-2-(trifluoromethyl)-2-butene (CH₃CF═C(CF₃)₂); 1,1,1-trifluoro-2-(trifluoromethyl)-2-butene ((CF₃)₂C═CHCH₃); 3,4,4,5,5,5-hexafluoro-2-pentene (CF₃CF₂CF═CHCH₃); 1,1,1,4,4,4-hexafluoro-2-methyl-2-butene (CF₃C(CH₃)═CHCF₃); 3,3,4,5,5,5-hexafluoro-1-pentene (CH₂═CHCF₂CHFCF₃); 4,4,4-trifluoro-2-(trifluoromethyl)-1-butene (CH₂═C(CF₃)CH₂CF₃); 1,1,2,3,3,4,4,5,5,6,6,6-dodecafluoro-1-hexene(CF₃(CF₂)₃CF═CF₂); 1,1,1,2,2,3,4,5,5,6,6,6-dodecafluoro-3-hexene(CF₃CF₂CF═CFCF₂CF₃); 1,1,1,4,4,4-hexafluoro-2,3-bis(trifluoromethyl)-2-butene((CF₃)₂C═C(CF₃)₂); 1,1,1,2,3,4,5,5,5-nonafluoro-4-(trifluoromethyl)-2-pentene ((CF₃)₂CFCF═CFCF₃); 1,1,1,4,4,5,5,5-octafluoro-2-(trifluoromethyl)-2-pentene ((CF₃)₂C═CHC₂F₅); 1,1,1,3,4,5,5,5-octafluoro-4-(trifluoromethyl)-2-pentene ((CF₃)₂CFCF═CHCF₃); 3,3,4,4,5,5,6,6,6-nonafluoro-1-hexene (CF₃CF₂CF₂CF₂CH═CH₂); 4,4,4-trifluoro-3,3-bis(trifluoromethyl)-1-butene (CH₂═CHC(CF₃)₃); 1,1,1,4,4,4-hexafluoro-3-methyl-2-(trifluoromethyl)-2-butene ((CF₃)₂C═C(CH₃)(CF₃)); 2,3,3,5,5,5-hexafluoro-4-(trifluoromethyl)-1-pentene (CH₂═CFCF₂CH(CF₃)₂); 1,1,1,2,4,4,5,5,5-nonafluoro-3-methyl-2-pentene (CF₃CF═C(CH₃)CF₂CF₃); 1,1,1,5,5,5-hexafluoro-4-(trifluoromethyl)-2-pentene (CF₃CH═CHCH(CF₃)₂); 3,4,4,5,5,6,6,6-octafluoro-2-hexene (CF₃CF₂CF₂CF═CHCH₃); 3,3,4,4,5,5,6,6-octafluorol-hexene (CH₂═CHCF₂CF₂CF₂CHF₂); 1,1,1,4,4-pentafluoro-2-(trifluoromethyl)-2-pentene ((CF₃)₂C═CHCF₂CH₃); 4,4,5,5,5-pentafluoro-2-(trifluoromethyl)-1-pentene (CH₂═C(CF₃)CH₂C₂F₅); 3,3,4,4,5,5,5-heptafluoro-2-methyl-1-pentene (CF₃CF₂CF₂C(CH₃)═CH₂); 4,4,5,5,6,6,6-heptafluoro-2-hexene (CF₃CF₂CF₂CH═CHCH₃); 4,4,5,5,6,6,6-heptafluoro-1-hexene (CH₂═CHCH₂CF₂C₂F₅); 1,1,1,2,2,3,4-heptafluoro-3-hexene (CF₃CF₂CF═CFC₂H₅); 4,5,5,5-tetrafluoro-4-(trifluoromethyl)-1-pentene (CH₂═CHCH₂CF(CF₃)₂); 1,1,1,2,5,5,5-heptafluoro-4-methyl-2-pentene (CF₃CF═CHCH(CF₃)(CH₃)); 1,1,1,3-tetrafluoro-2-(trifluoromethyl)-2-pentene ((CF₃)₂C═CFC₂H₅); 1,1,1,2,3,4,4,5,5,6,6,7,7,7-tetradecafluoro-2-heptene (CF₃CF═CFCF₂CF₂C₂F₅); 1,1,1,2,2,3,4,5,5,6,6,7,7,7-tetradecafluoro-3-heptene (CF₃CF₂CF═CFCF₂C₂F₅); 1,1,1,3,4,4,5,5,6,6,7,7,7-tridecafluoro-2-heptene (CF₃CH═CFCF₂CF₂C₂F₅); 1,1,1,2,4,4,5,5,6,6,7,7,7-tridecafluoro-2-heptene (CF₃CF═CHCF₂CF₂C₂F₅); 1,1,1,2,2,4,5,5,6,6,7,7,7-tridecafluoro-3-heptene (CF₃CF₂CH═CFCF₂C₂F₅); and 1,1,1,2,2,3,5,5,6,6,7,7,7-tridecafluoro-3-heptene (CF₃CF₂CF═CHCF₂C₂F₅).

11. The composition of claim 1, further comprising a metal deactivator selected from the group consisting of areoxalyl bis(benzylidene)hydrazide; N,N′-bis(3,5-di-tert-butyl-4-hydroxyhydrocinnamoylhydrazine); 2,2′-oxamidobis-ethyl-(3,5-d-tert-butyl-4-hydroxyhydrorcinnamate); N,N′-(disalicyclidene)-1,2-propanediamine; ethyenediaminetetraacetic acid and salts thereof; triazoles; benzotriazole, 2-mercaptobenzothiazole, tolutriazole derivatives, N,N-disalicylidene-1,2-diaminopropane, and mixtures thereof

12. A process for producing cooling comprising condensing the composition of claim 1 and thereafter evaporating said composition in the vicinity of a body to be cooled.

13. A process for producing heat comprising condensing the composition of claim 1 in the vicinity of a body to be heated, and thereafter evaporating said composition.

14. A method for reducing degradation of a composition comprising CF₃I, wherein said degradation is caused by the presence of inadvertent air in a refrigeration, air-conditioning or heat pump system, said method comprising adding an effective amount of at least one ionic liquid to the composition comprising CF₃I.

15. A method for reducing reaction with oxygen for a composition comprising CF₃I; said method comprising adding an effective amount of stabilizer comprising at least one ionic liquid to the composition comprising CF₃I.
